(19) United States
(12) Patent Application Publication
(10) Pub. No.: US 2025/0270808 A1
(43) Pub. Date: Aug. 28, 2025

(54) BUILDING FAÇADE SYSTEM INCLUDING CEMENTITIOUS FAÇADE PANELS AND METHOD OF MANUFACTURING AND INSTALLING THE PANELS

(71) Applicant: Talon Wall Holdings, LLC, South Holland, IL (US)

(72) Inventor: Kurtis E LeVan, South Holland, IL (US)

(73) Assignee: Talon Wall Holdings, LLC, South Holland, IL (US)

(21) Appl. No.: 19/061,160

(22) Filed: Feb. 24, 2025

Related U.S. Application Data
(60) Provisional application No. 63/557,822, filed on Feb. 26, 2024.

(51) Int. Cl. E04B 2/96; E04B 2/94; E06B 3/54

(52) U.S. Cl. CPC E04B 2/96; E04B 2/94; E06B 3/5418

(57) ABSTRACT

A building façade is secured to a building structure having a plurality of vertically stacked levels defined by horizontally arranged floors therebetween. The façade includes a framework which is mounted to one or more of the floors and one or more cementitious façade panels which are mounted to the framework. The cementitious façade panels include a cementitious planar member and a glazing frame secured to the cementitious planar member. The cementitious façade panels are mounted to the framework by adhering the glazing frame to the framework. The framework can be mounted to one or more of the floors before or after the cementitious façade panels are mounted thereto. Preferably, the glazing frame is adhered to the framework by structural spacer tape and/or structural sealant, and the glazing frame includes anchor studs embedded in the cementitious planar member.

### CROSS REFERENCE TO RELATED APPLICATION

This application claims benefit under 35 U.S.C. 119 (e) to provisional application Ser. No. 63/557,822 filed on Feb. 26, 2024, the disclosure of which is hereby incorporated by reference.

### INCORPORATION BY REFERENCE

The specifications, drawings, and claims of LeVan, U.S. Pat. No. 10,724,234; LeVan, U.S. Pat. No. 10,202,764; LeVan, U.S. Pat. No. 9,752,319; LeVan, U.S. Pat. No. 10,094,111; LeVan, U.S. Pat. No. 10,233,638; and LeVan, U.S. Prov. Pat. App. Ser. No. 63/419,182 (collectively, the “LeVan Patents”) are hereby incorporated by reference in their entirety.

### BACKGROUND OF THE INVENTION

### 1. Field of the Invention

The present invention relates to the field of façade systems which form a wall or shell around buildings. More particularly, the present invention relates to cementitious curtain wall panels and methods of manufacturing and incorporating/installing cementitious curtain wall panels in building façade frameworks between successive floors of the building.

### 2. Background

Building façade systems are known and are common; they form a curtain wall around buildings and protect the building from the elements. Curtain walls typically comprise a plurality of panels supported on a framework which are hung and/or are otherwise secured to the building structure. The panels and framework can be made of various materials such as glass, stone, concrete, polymers, steel, aluminum, etc., and can be various sizes as needed or desired. The panels can also be insulated, and different types of panels can be used for different purposes. Glass panels are commonly used between the floor slabs to provide windows for the building, and concrete or polymer panels are commonly used to cover building structural components or form architecturally aesthetically pleasing building exterior shapes and curtain wall surfaces.

Curtain wall panels made from glass or other similar materials are typically sized to fit within the curtain wall frameworks whereby the panels can be adhered through a process commonly referred to as structural sealant glazing. Structural sealant glazing typically involves applying a structural spacer tape inboard of, and extending parallel to, the perimeter edges of the panel. After the structural spacer tape has been applied, the panel is positioned within the curtain wall framework with the structural spacer tape sandwiched between the panel and the curtain wall framework such that a gap/slot is formed between the panels and the framework along the perimeter edges thereof.

After the panel is properly positioned, a structural glazing sealant is applied into and fills the gaps/slots, wherein the structural glazing sealant and the structural spacer tape, together, adhere and secure the panels to the curtain wall framework. The structural glazing sealant can be, for example, a structural silicone sealant adapted for adhering and supporting the panels and for providing an airtight, weatherseal between the panels and the framework. The airtight, weatherseal also prevents water from penetrating through the gaps/slots and reduces corrosion and damage to the framework.

Panels made from glass or other materials can also be secured to curtain wall frameworks by encapsulating or clamping the perimeter edges of the panels to the framework using a compression gasket system. In these systems, the panels are mounted by positioning the panels within the framework with a compression gasket sandwiched between the framework and the perimeter edges of the panels. Compression gasket plates or strips are then secured to the framework whereby the perimeter edges of the panels are clamped between the compression gasket plates or strips and the framework.

Traditionally, concrete or polymer curtain wall panels are formed by casting, molding, or otherwise forming a unitary material to produce a panel having the desired architecturally aesthetically pleasing shape. Traditional concrete or polymer panels, however, cannot be adhered to the curtain wall frameworks via glazing. Cementitious materials typically provide poor adhesive surfaces, and structural glazing sealants cannot form a sufficient bond between the concrete or polymer panel and the framework for supporting the panel's weight. Additionally, the perimeter edge surfaces of panels which are encapsulated or clamped to the framework must be smooth and have precise tolerances to ensure a strong, weathertight seal is formed. The perimeter edge surfaces of concrete or polymer panels are typically rough, porous, and uneven, making it not feasible to encapsulate or clamp these edges into a curtain wall framework with a compression gasket system. As such, concrete or polymer panels are traditionally supported by studs, tabs, brackets, or bolt type attachment hardware periodically bonded to, or embedded within, the perimeter structure of the panel itself. These hardware attachments are then mechanically fastened to either the curtain wall framework directly or to a separate steel grid system attached to the floor slab structure of the building.

Of course, this traditional method of mounting concrete or polymer panels requires exterior access to the façade systems, which can be difficult and time consuming and typically increases the cost of installation. When a separate steel grid system is required, the steel grid system adds significant undesirable weight to the building structure. Alternatively, if the panels are directly, mechanically fastened to the curtain panel framework, the attachment hardware often penetrates and separates the airtight, weatherseal of the framework and thereby creates potential points of failure.

Accordingly, a need exists for an improved, more efficient, and cost-effective cementitious panel which can be manufactured and installed while maintaining the airtight, weatherseal of the framework and reducing the weight supported by the building structure.

### SUMMARY OF THE INVENTION

In the present invention, a building façade secured to a building structure comprising a plurality of vertically stacked levels defined by horizontally arranged floors therebetween can comprise a framework and one or more cementitious façade panels. The cementitious façade panels can comprise a cementitious planar member and a glazing frame secured to the cementitious planar member. The framework is mounted to one or more of the floors and the cementitious façade panels are mounted to the framework by adhering the glazing frames thereto. Preferably, the cementitious façade panels can be mounted to the framework before or after the framework is mounted to one or more of the floors.

Preferably, the glazing frame is embedded into the cementitious planar member during manufacture thereof. Yet more preferably, the glazing frame comprises a plurality of anchor studs, and the anchor studs are embedded into the cementitious planar member during manufacture thereof for thereby securing the glazing frame thereto.

Preferably, the framework is adhered to the glazing frame by a sealant applied along a perimeter of the glazing frame and/or a tape sandwiched between the glazing frame and the framework. Yet more preferably, the tape is a structural spacer tape which spaces the glazing frame apart from the framework for thereby forming gaps/slots therebetween, and a structural sealant fills the gaps/slots and forms an airtight, weatherseal along the perimeter of the glazing frame.

Preferably, the framework comprises a horizontal shelf member, a pair of vertical mullions hung from the horizontal shelf member, and a horizontal infill support member secured to, and extending between, lower terminal ends of pair of vertical mullions. A rectangular closure frame is formed and defined between the horizontal shelf member, the pair of vertical mullions, and the infill support member, and the cementitious façade panel can be sized to fit within and be adhered to the rectangular closure frame.

Yet more preferably the framework comprises a horizontal shelf member, a pair of vertical mullions hung from the horizontal shelf member, a horizontal infill support member secured to, and extending between, lower terminal ends of pair of vertical mullions, and a horizontal edge cover support member secured to, and extending between, the pair of vertical mullions vertically between the horizontal shelf member and the horizontal infill support member. A rectangular closure frame is formed and defined between the horizontal shelf member, the pair of vertical mullions, and the infill support member, a rectangular infill frame is formed and defined between horizontal edge cover support member, the pair of vertical mullions, and the infill support member, and a rectangular edge cover frame is formed and defined between the horizontal shelf member, the pair of vertical mullions, and the infill support member. The cementitious façade panel can be sized to fit within and be adhered to one of the rectangular closure frame, the rectangular infill frame, or the rectangular edge cover frame.

Preferably, the cementitious planar member can be a flat/planar panel and can be hollow for thereby reducing the weight thereof.

Yet more preferably, the cementitious planar member is pan-shaped comprising protruding perimeter walls extending perpendicularly away from the glazing frame, planar exterior walls extending between the protruding perimeter walls, and a hollow cavity formed and defined between the protruding perimeter walls and the planar exterior walls.

Preferably, the glazing frame can be integrally formed from a unitary material such as by molding, or the glazing frame can be constructed from a plurality of elongate members formed by either cutting desired lengths from a stock material or by extruding, injection molding, casting or otherwise molding, forming or shaping from a unitary material.

Preferably, the plurality of elongate members comprise glazing walls and a plurality of anchor studs secured to the glazing walls. The framework can be adhered to the glazing walls, and the anchor studs can be embedded into the planar cementitious member during manufacture thereof for securing the glazing frame thereto.

Preferably, the plurality of elongate members further comprise side walls extending perpendicularly from the glazing walls, and one or more gaskets can engage the side walls for thereby forming a weatherseal along a perimeter of the cementitious façade panel. Yet more preferably, the plurality of elongate members further comprise intermediate connector walls extending between the glazing walls and the side walls. A plurality of anchor studs can be secured to the intermediate connector walls, and the anchor studs can be embedded into the cementitious planar member during manufacture thereof.

Preferably, the cementitious planar member comprises one of more of gypsum, concrete, polymers, plastics, resins, carbon, and/or binders with or without embedded reinforcing fibers or metal or metal alloy members.

In another embodiment of the present invention, a method of manufacturing and installing a building façade on a building structure comprising a plurality of vertically stacked levels defined by horizontally arranged floors therebetween, wherein the building façade comprises a framework and one or more cementitious façade panels, can comprise the steps of: assembling the framework; securing a glazing frame to a cementitious planar member to thereby produce a cementitious façade panel; mounting the framework to one or more of the floors; and mounting the cementitious façade panel to the framework by adhering the glazing frame thereto.

Preferably, the step of securing the glazing frame to the cementitious planar member comprises the steps of placing the glazing frame into a mold and filling the mold with a liquid cementitious material whereby, as the liquid cementitious material solidifies/cures, the planar cementitious member is formed, and the glazing frame is embedded therein.

Yet more preferably, the step of securing the glazing frame to the cementitious planar member comprises the steps of placing the glazing frame into a mold, placing a removable core into the mold inside of the glazing frame, filling or spraying a liquid cementitious material into the mold, removing the glazing frame and the cementitious planar member from the mold after the liquid cementitious material solidifies/cures, and removing the removable core from inside of the glazing frame whereby the removable core forms a hollow cavity within the cementitious planar member for thereby reducing the weight thereof.

Preferably, the step of adhering the glazing frame to the framework comprises the steps of either applying tape to either the glazing frame or the framework and sandwiching the tape between the glazing frame and the framework, or positioning the glazing frame adjacent to the framework and applying a sealant to the glazing frame and the framework along a perimeter edge of the glazing frame, wherein the tape or the sealant adheres the glazing frame to the framework.

Yet more preferably, the step of adhering the glazing frame to the framework comprises the steps of applying a structural spacer tape to either the glazing frame or the framework, sandwiching the structural spacer tape between the glazing frame and the framework whereby the structural spacer tape spaces the glazing frame apart from the framework for forming slots/gaps therebetween, and filling the slots/gaps with a structural sealant, wherein the structural spacer tape and the structural sealant together adhere the glazing frame to the framework.

In another embodiment of the present invention, a building façade secured to a building structure comprising a plurality of vertically stacked levels defined by horizontally arranged floors therebetween can comprise a framework, one or more cementitious façade panels, and one or more plates which mount to the framework. The cementitious façade panels can comprise a cementitious planar member and a glazing frame secured to the cementitious planar member. The framework is mounted to one or more of the floors and the cementitious façade panels are mounted to the framework by sandwich and clamping the glazing frame between the one or more plates and the framework.

### BRIEF DESCRIPTION OF THE DRAWINGS

The above-mentioned and other features of this invention and the manner of attaining them will become more apparent, and the invention itself will be better understood by reference to the following description of the embodiments of the invention, taken in conjunction with the accompanying drawings, wherein:

FIGS. 1A-C are diagrammatic perspective views of façade systems constructed in accordance with the principles of the present invention on a building;

FIGS. 2A-C are partial side elevation views of embodiments of the frameworks of the façade systems shown in FIGS. 1A-C and wherein the closure panels, infill panels, and edge cover panels have been removed for clarity;

FIG. 3 is a perspective view of the framework shown in FIG. 2;

FIG. 4 is an exploded perspective view of the framework;

FIG. 5 is a cross section view of the façade system shown in FIG. 1A taken along the line 5-5 shown in FIG. 2, wherein the façade system comprises pan-shaped cementitious closure panels;

FIG. 6A is a cross section view of the façade system shown in FIG. 1B taken along the line 5-5 shown in FIG. 2, wherein the façade system comprises flat/planar cementitious closure panels;

FIG. 6B is a cross section view of the façade system shown in FIG. 1B taken along the line 5-5 shown in FIG. 2, wherein the façade system comprises flat/planar cementitious infill and slab edge cover panels;

FIG. 7A is a cross section view of the façade system shown in FIG. 1C taken along the line 5-5 shown in FIG. 2, wherein the façade system comprises cementitious infill panels;

FIG. 7B is a cross section view of the façade system shown in FIG. 7A, wherein the façade system comprises cementitious edge cover panels;

FIG. 8 is a cross section view of the façade system taken along the line 5-5 shown in FIG. 2, wherein the façade system comprises glass edge cover panels and glass infill panels;

FIG. 9A is a magnified cross section view of the façade system shown in FIG. 6A;

FIG. 9B is an exploded cross section view of the façade system shown in FIG. 9A;

FIG. 10A is a magnified cross section view of the façade system shown in FIG. 7A;

FIG. 10B is an exploded cross section view of the façade system shown in FIG. 10A;

FIG. 11A is a cross section view of the façade system shown in FIG. 1A taken along the line 11-11 shown in FIG. 2, and showing a pan-shaped cementitious closure panel adjacent a glass infill panel secured to a mullion therebehind;

FIG. 11B is an exploded cross section view of the façade system shown in FIG. 11A;

FIGS. 12A-C are cross section views of cementitious panels, similar to the cross section of the cementitious façade panel shown in FIG. 11A, and depicting various embodiments of the embedded support/glazing frames;

FIGS. 13A-B are perspective views illustrating the assembly of a support/glazing frame;

FIG. 14 is a perspective view of an assembled support/glazing frame;

FIG. 15 is a perspective view of a support/glazing frame being inserted into a mold;

FIG. 16 is a perspective view of a removable core being inserted into the mold and within the support/glazing frame;

FIG. 17 is a perspective view of the mold after it has been filled with a cementitious material to form a cementitious closure panel;

FIG. 18A is a cross section view taken along the line 18-18 shown in FIG. 17 and depicting the mold while forming a flat/planar cementitious panel as shown in FIGS. 6, 7A, 7B, 9A, 9B, 10A and 10B;

FIG. 18B is a cross section view taken along the line 18-18 shown in FIG. 17 and depicting the mold while forming a cementitious pan shaped panel as shown in FIGS. 5, 11A, 11B and 12A-C;

FIGS. 19A-B are perspective views illustrating securement of a cementitious closure panel to a framework using structural spacer tape and structural sealant; and,

FIG. 20 is a perspective view illustrating installation of a cementitious closure panel and framework on a building floor slab.

FIG. 21 is a partial side elevation view of an embodiment of the façade system incorporating a traditional curtain wall framework wherein the closure panels have been removed for clarity;

FIG. 22 is an exploded perspective view of the traditional framework shown in FIG. 21;

FIG. 23 is a partially exploded perspective view of the façade system shown in FIG. 21 wherein cementitious closure panels and insulated glass closure panels are mounted to the traditional framework;

FIG. 24 is a cross section view of the facade system shown in FIG. 23 taken along the line 24-24 shown in FIG. 21;

FIG. 25 is another cross section view of the façade system taken along the line 25-25 shown in FIG. 21;

FIG. 26 is a partially exploded perspective view of another embodiment of the façade system wherein the closure panels are clampingly mounted to the traditional framework by weatherseal plates;

FIG. 27 is a cross section view of the facade system shown in FIG. 26 taken along the line 24-24 shown in FIG. 21;

FIG. 28 is a cross section view of the facade system shown in FIG. 26 taken along the line 25-25 shown in FIG. 21;

FIG. 29A is a magnified cross section view of the façade system shown in FIG. 6A wherein the cementitious panels are adhered to the talon wall framework by a structural glazing sealant alone/without structural spacer tape;

FIG. 29B is a magnified cross section view of the façade system shown in FIG. 6A wherein the cementitious panels are adhered to the talon wall framework by structural spacer tape alone/without a structural glazing sealant;

FIG. 30A is a magnified cross section view of the façade system shown in FIG. 24 wherein the cementitious panels are adhered to the traditional framework by a structural glazing sealant alone/without structural spacer tape; and

FIG. 30B is a magnified cross section view of the façade system shown in FIG. 24 wherein the cementitious panels are adhered to the traditional framework by structural spacer tape alone/without a structural glazing sealant.

Corresponding reference characters indicate corresponding parts throughout several views. Although the exemplification set out herein illustrates certain embodiments of the invention, the embodiments disclosed below are not intended to be exhaustive or to be construed as limiting the scope of the invention to the precise form disclosed.

### DETAILED DESCRIPTION OF THE PREFERRED EMBODIMENTS

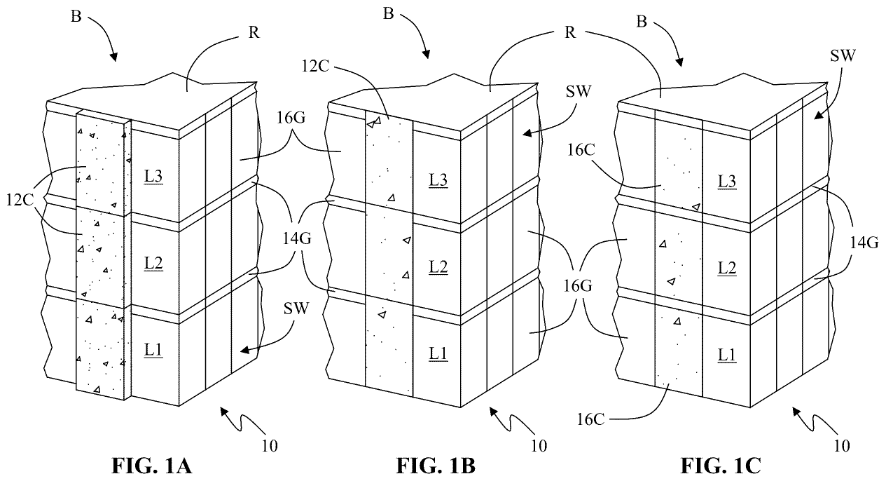

Referring initially to FIGS. 1A-C, a building façade system constructed in accordance with the principles of the present invention is generally designated by the numeral 10 and is installed on a building B. Building B includes a roof R and multiple side walls SW. Building B can, of course, be arranged in a wide variety of shapes and include any number of side walls SW. Building B can further comprise any number of floors or levels as needed or architecturally desired.

Building B is diagrammatically depicted and is shown having three levels L1, L2, and L3. Concrete, steel and/or steel and concrete floor slabs FS are constructed and supported between each of the levels L1, L2, L3 in a known and customary manner. The floor slabs FS each include a top surface TS, an underside surface US and a terminal edge surface ES. The terminal edge surfaces ES of each floor slab FS are generally coplanar with one another.

The façade system 10 is secured to the floor slabs FS and forms an outer curtain wall or shell which is architecturally aesthetically pleasing and protects the building from the elements. The façade system 10 can be formed from a plurality of curtain panels supported on a framework 18/100. As shown in FIGS. 1A-C, the curtain panels can include a plurality of closure panels 12, slab edge cover panels 14, and/or infill panels 16. The closure panels 12 cover the floor slab terminal edge surfaces ES and also extend between successive floor slabs FS for enclosing the building interior space at each level L1, L2, and L3. The closure panels 12 can be used for forming architecturally, aesthetically pleasing exterior façade elements, such as, for example, façade columns, and also for generally covering/obscuring the building structural components.

The slab edge cover panels 14 extend along and generally cover the floor slab terminal edge surfaces ES. The infill panels 16 extend between slab edge cover panels 14 and enclose the building interior space at each level L1, L2, and L3 between successive floor slabs. The slab edge cover panels 14 and the infill panels 16 can be used in place of the closure panels 12 whereby the vertical space between the floor slabs FS can be split up and different panels can be used in the spaces thereof as needed or architecturally desired.

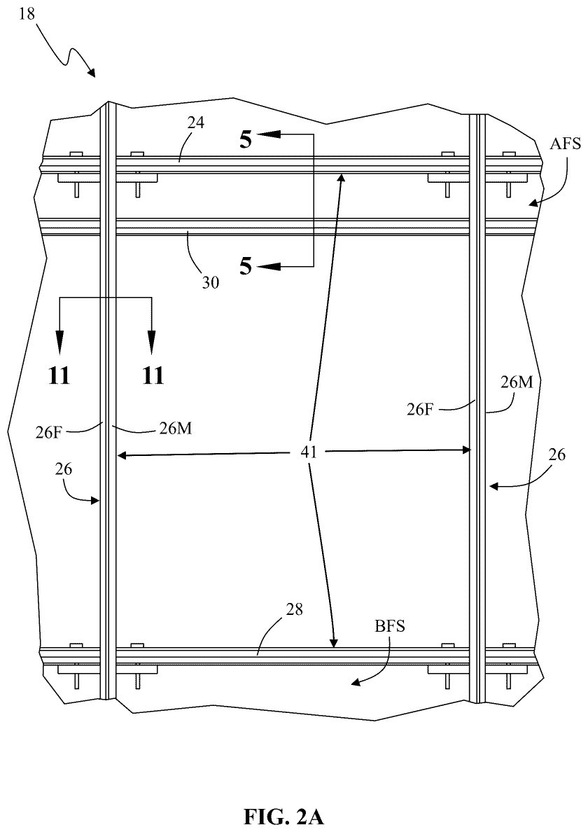

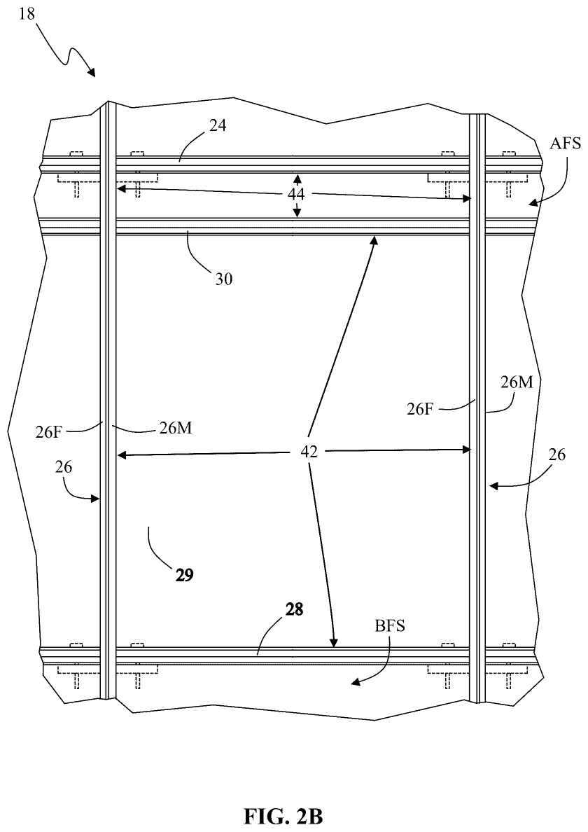

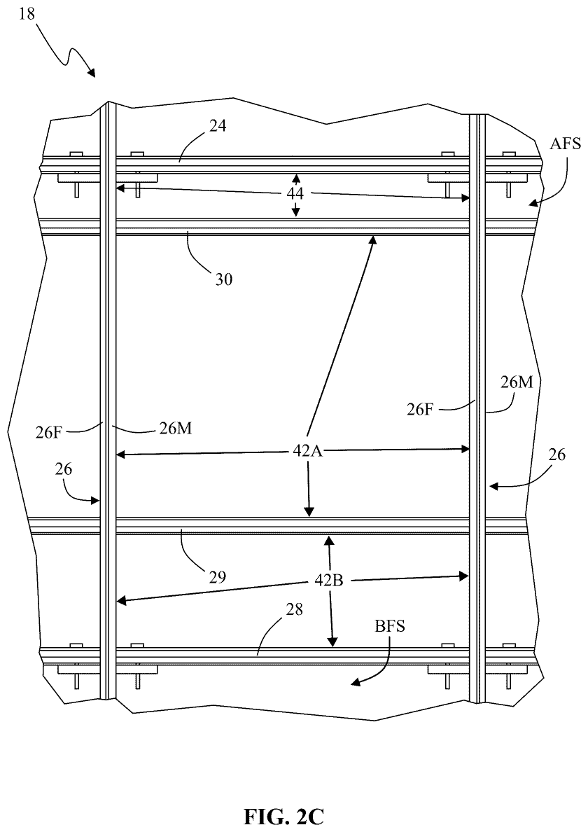

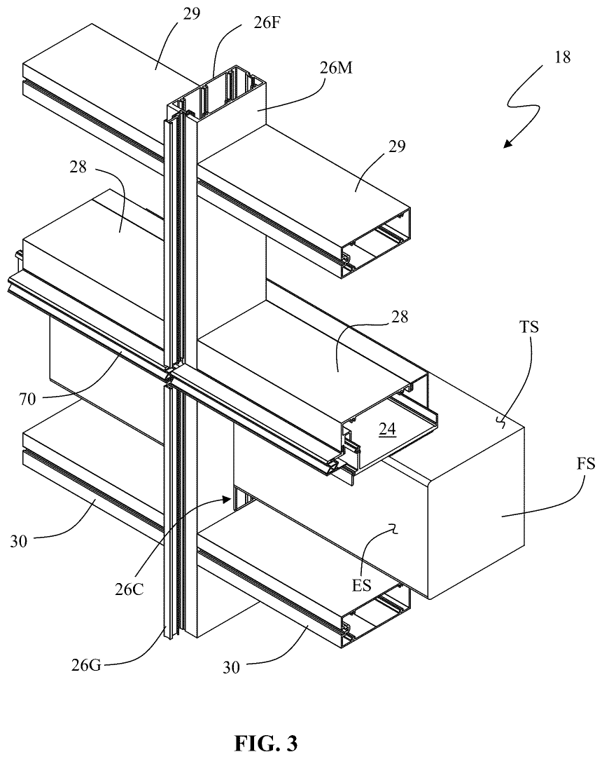

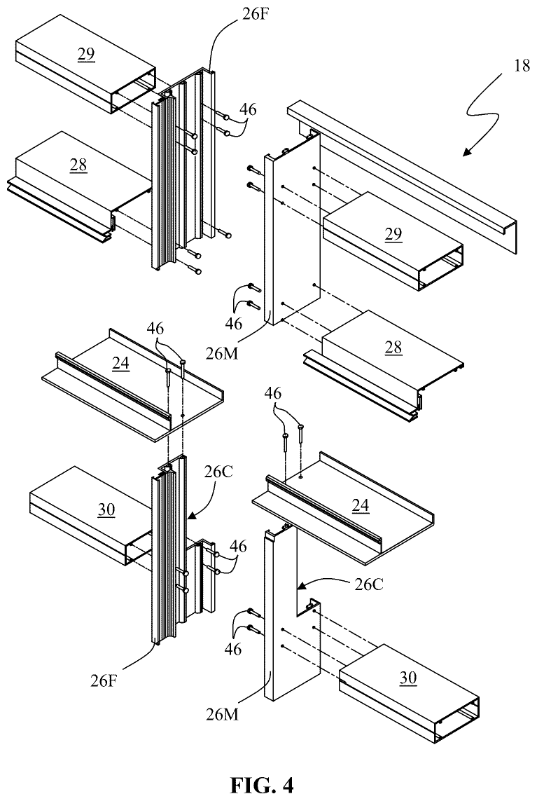

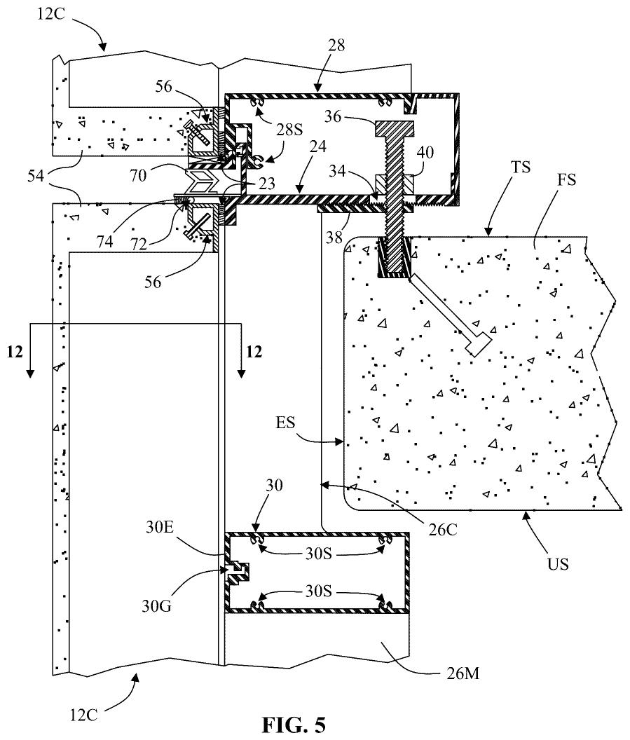

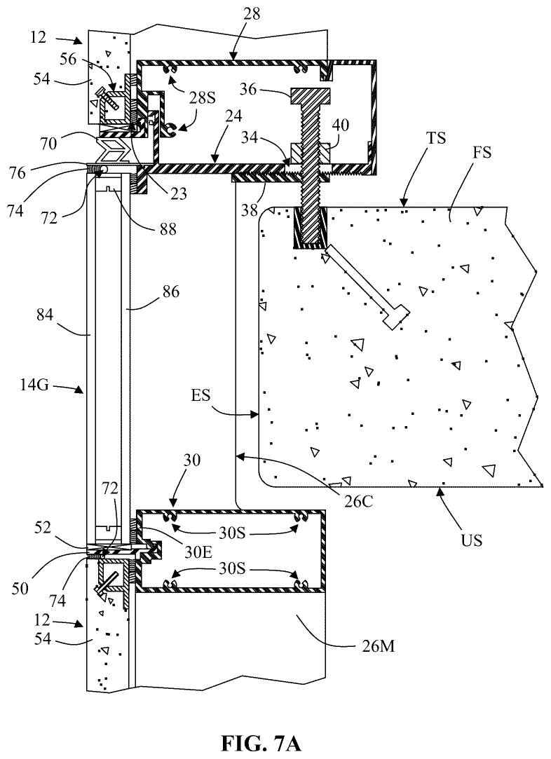

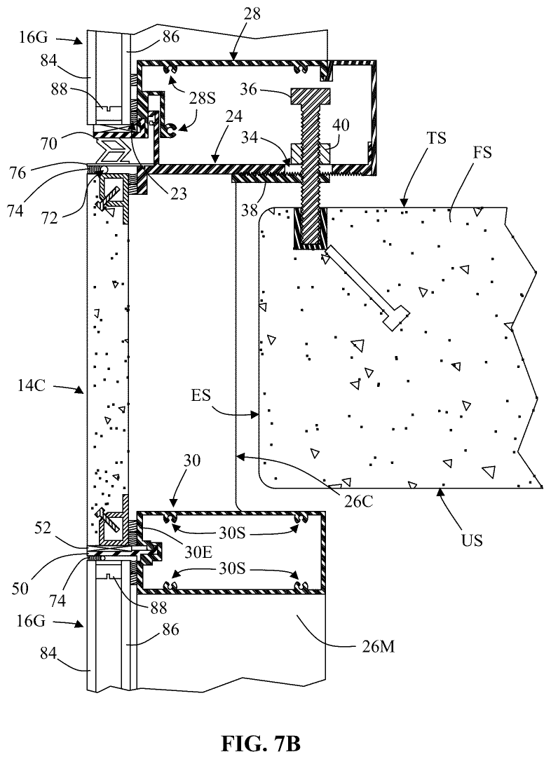

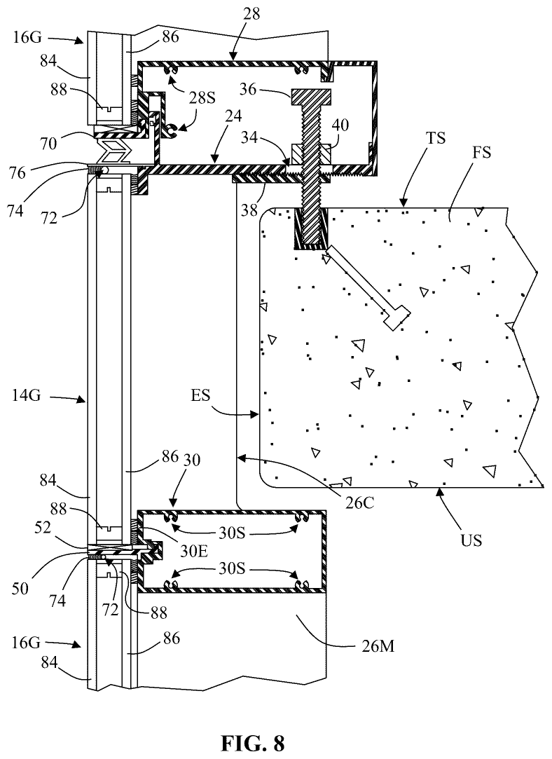

As best seen in FIGS. 2-4, 22, 23, and 26, the framework 18/100 consists of components preferably, in large part, made of extruded aluminum, although other materials can also be used such as painted or galvanized steel, wood, etc. As shown in FIGS. 5-8, 24, and 25, the framework 18/100 is mounted the floor slab FS of one or more building levels L1, L2, L3 and functions to, for each building level L1, L2, L3, support the panels 12, 14, 16 of that building level. For clarity and reference in this regard, as depicted in FIG. 2, for any level L1, L2, L3, the floor slab FS directly above that building level is herein referred to as the “above” floor slab AFS and the floor slab FS directly below the above floor slab AFS is herein referred to as the “below” floor slab BFS.

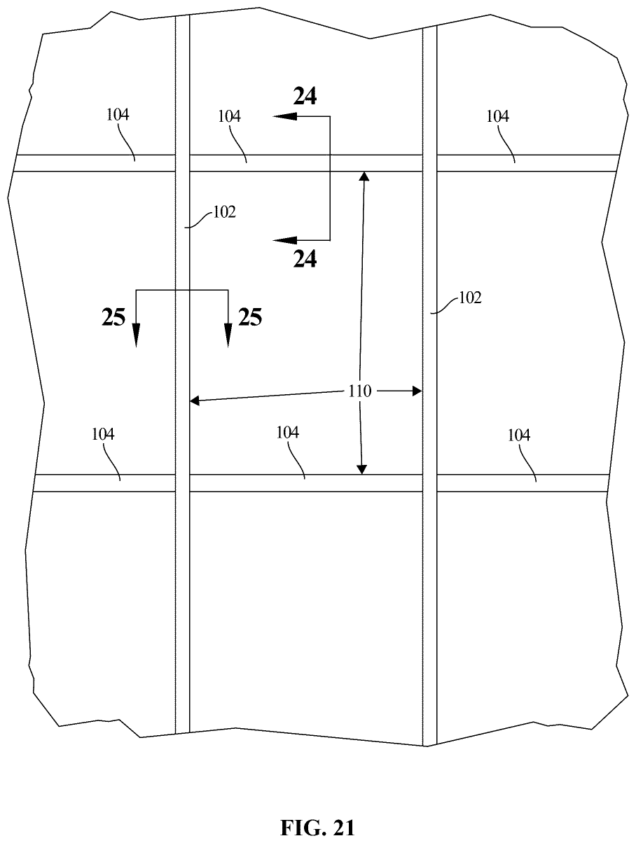

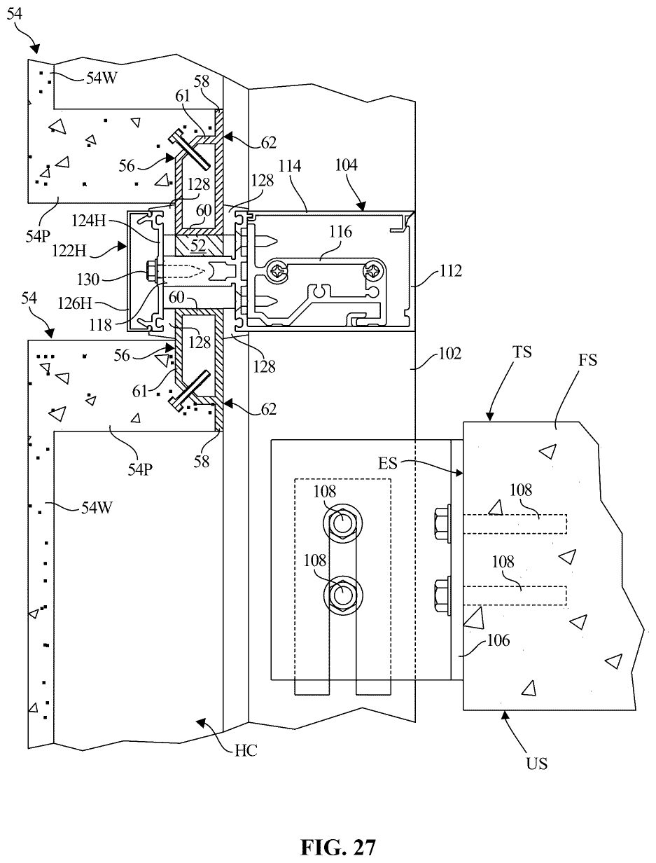

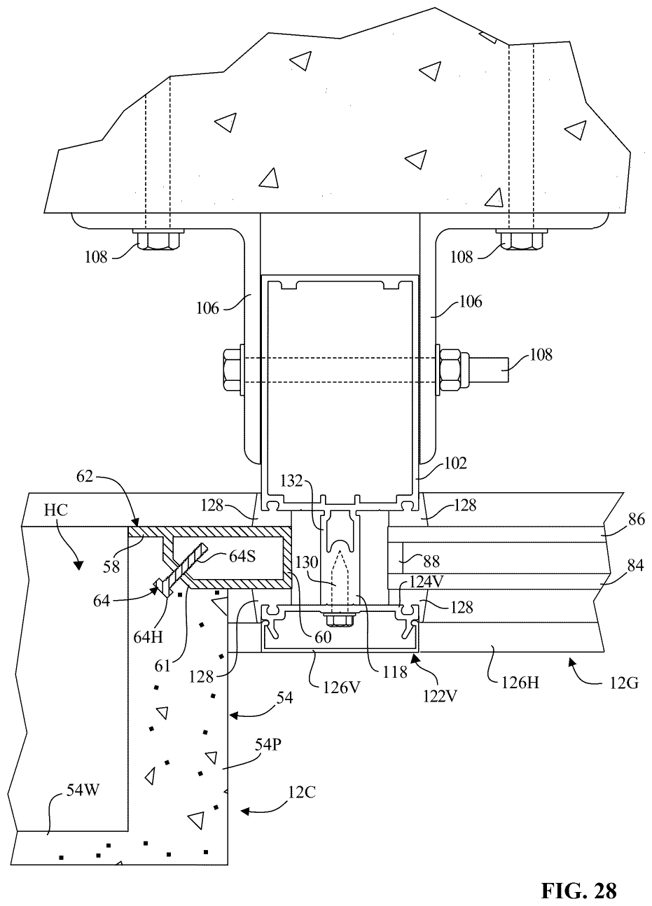

It is contemplated that the framework 18/100 can comprise any framework configured to support panels for forming a building façade system. For example, the framework 18/100 can comprise a “talon wall” framework 18 disclosed in the Le Van Patents and shown in FIGS. 2-11, 19, and 20 which is configured to be hung from an above floor slab AFS or a traditional curtain wall framework 100 such as the Kawneer 1600 Wall System shown in FIGS. 21-28 which is secured to one or more of the floor slabs FS and forms an exoskeleton around the building B.

In the first embodiment, as best seen in FIGS. 2-4, the talon wall framework 18 can include horizontal shelf members 24, vertical mullions 26, horizontal infill support members 28, and intermediate horizontal edge cover support members 30. The horizontal shelf members 24 are secured to the floor slabs FS above the top surfaces TS thereof. The vertical mullions 26 are secured to the horizontal shelf members 24 and extend vertically downwardly therefrom toward the below floor slabs BFS therebelow. The horizontal infill support members 28 extend between, and are secured to, the lower terminal ends of adjacent pairs of vertical mullions 26. The intermediate horizontal edge cover support members 30 are located vertically between the infill support members 28 and the shelf members 24 and extend between, and are secured to, the adjacent pairs of vertical mullions 26.

Preferably, the infill support members 28 are configured to be coupled to the horizontal shelf members 24 which are secured to the below floor slab BFS. Yet more preferably, the infill support members 28 and the horizontal shelf members 24 secured to the below floor slab BFS are configured to be coupled together such that they are moveable vertically, but not horizontally, relative to each other as described in the LeVan patents.

The panels 12, 14, 16 are sized to fit within and be adhered to “frames” formed and defined between the shelf members 24, the vertical mullions 26, the infill support members 28, and/or the edge cover support members 30, respectively. More particularly, a plurality of rectangular closure frames 41 (FIG. 2A) are formed and defined between the adjacent pairs of vertical mullions 26, the infill support members 28, and the shelf members 24.

The edge cover support members 30 divide the plurality of closure frames 41 into a plurality of infill frames 42 and slab cover frames 44 (FIG. 2B). The infill frames 42 are formed by and defined between the adjacent pairs of vertical mullions 26, the infill support members 28, and the edge cover support members 30. Similarly, the slab cover frames 44 are formed and defined between the adjacent pairs of vertical mullions 26, the edge cover support members 30, and the shelf members 24.

The closure panels 12 can be sized to fit within and be adhered to the rectangular closure frames 41, the infill panels 16 can be sized to fit within and be adhered to the rectangular infill frames 42, and the slab edge cover panels 14 are sized to fit within and be adhered to the rectangular slab cover frames 44. More particularly, the closure panels 12 are supported on the infill support members 28 and are adhered along their perimeter edges to the adjacent pairs of vertical mullions 26, the infill support members 28, and the shelf members 24. The infill panels 16 are supported on the infill support members 28 and are adhered along their perimeter edges to the adjacent pairs of vertical mullions 26, the infill support members 28, and the edge cover support members 30. The edge cover panels 14 are supported on the edge cover support members 30 and are adhered along their perimeter edges to the adjacent pairs of vertical mullions 26, the edge cover support members 30, and the shelf members 24.

As best seen in FIGS. 2C, 3, and 4, the talon wall framework 18 can further include additional infill support members 29 located vertically between the lower infill support members 28 and edge cover support members 30 and extending between, and secured to, the adjacent pairs of vertical mullions 26. The additional infill support members 29 subdivide the infill frames 42 whereby the vertical space between the floor slabs FS can be further split up such that different infill panels 16 can be used in the spaces thereof as needed or architecturally desired. For example, as shown in FIG. 2C, the additional infill support members 29 can subdivide the infill frames 42 into infill subframes 42A, 42B whereby different infill panels 16 can be sized to fit within and be adhered to the infill subframes 42A, 42B as needed or architecturally desired.

The talon wall framework 18 can be supported/hung on and secured to the floor slabs FS using, for example, as shown and described in greater detail in the LeVan Patents, panel position adjustment mechanisms adapted to engage and bear upon the floor slabs FS. The panel position adjustment mechanisms can include shelf member slots 34 extending horizontally through the shelf members 24, posts 36 received through the shelf member slots 34 and bearing upon the floor slab FS (on the top surfaces TS and/or an embedded channel), support pads 38 threadingly secured to the posts and engaging and supporting the shelf members 24 above the floor slab top surfaces TS, and locknuts 40.

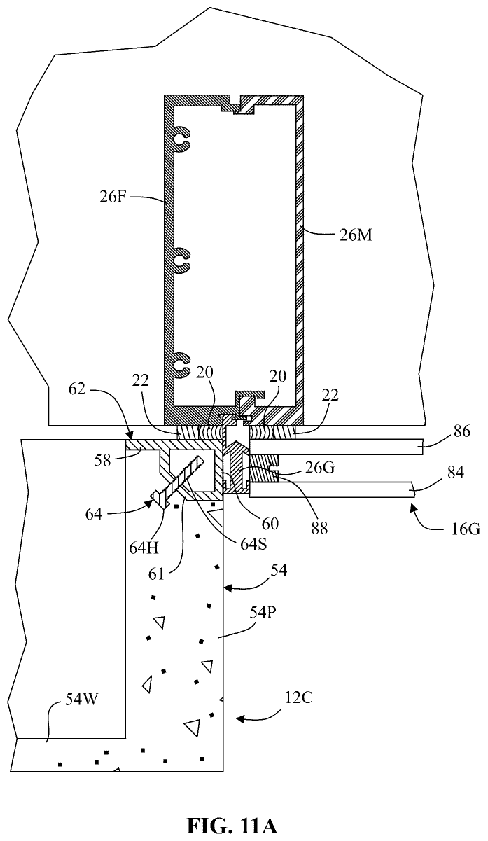

Returning to the vertical mullions 26, as best seen in FIG. 11, the vertical mullions 26 are rectangular shaped in cross section and comprise a female pan shaped half 26f and a male pan shaped half 26m. The male and female halves 26m, 26f securely snap together to form the rectangular shaped vertical mullions 26 in a known and customary manner. As best seen in FIGS. 5-8, an inside portion of the vertical mullion halves 26f, 26m can be milled or otherwise removed for thereby providing a cutout or notch 26C on the inside portion of the vertical mullions 26. The terminal part of the floor slab FS and the floor slab terminal edge surfaces ES project into and are received in the cutouts 26C. The cutouts 26C thereby, advantageously, allow the infill panels 16, the slab edge cover panels 14, and the closure panels 12 to be located closer to the slab edge terminal surfaces ES.

The shelf members 24 include fastener bores (FIG. 4) extending vertically through the shelf members 24 and adapted to receive frame fasteners 46 therethrough. The frame fasteners 46 are configured to extend through the fastener bores and threadingly engage the pair of male and female mullion halves 26m, 26f for thereby securing the male and female halves 26m, 26f to the shelf member 24. A sealant (not shown) can be applied completely covering the frame fasteners 46 for thereby creating a watertight seal.

The infill support members 28 and the edge cover support members 30 include infill support splines 28S and edge cover support splines 30S, respectively, adapted to threadingly receive frame fasteners 46. The vertical mullion halves 26m, 26f include corresponding fastener bores (FIG. 4) aligned with the support splines 28S, 30S. The fastener bores are adapted to receive frame fasteners 46 therethrough such that the frame fasteners 46 can engage the support splines 28S, 30S and thereby secure the infill support members 28 and the edge cover support members 30 to the vertical mullion halves 26m, 26f.

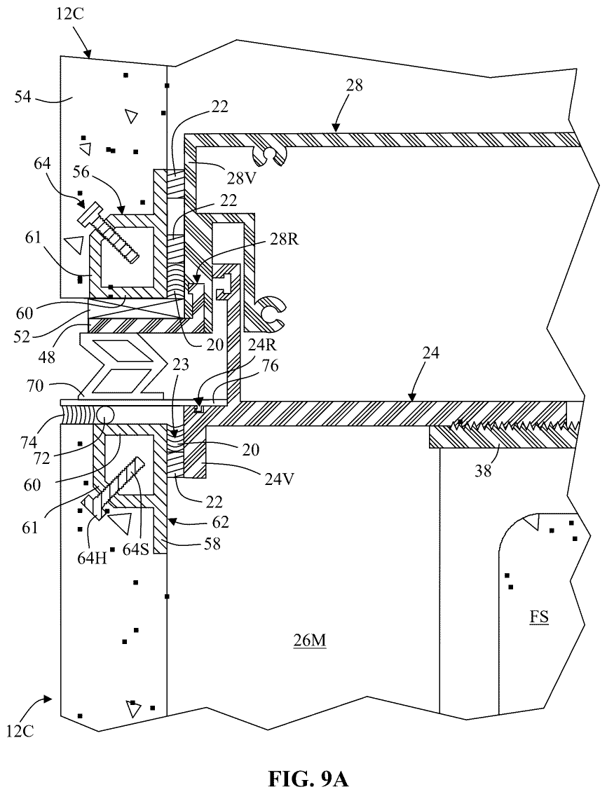

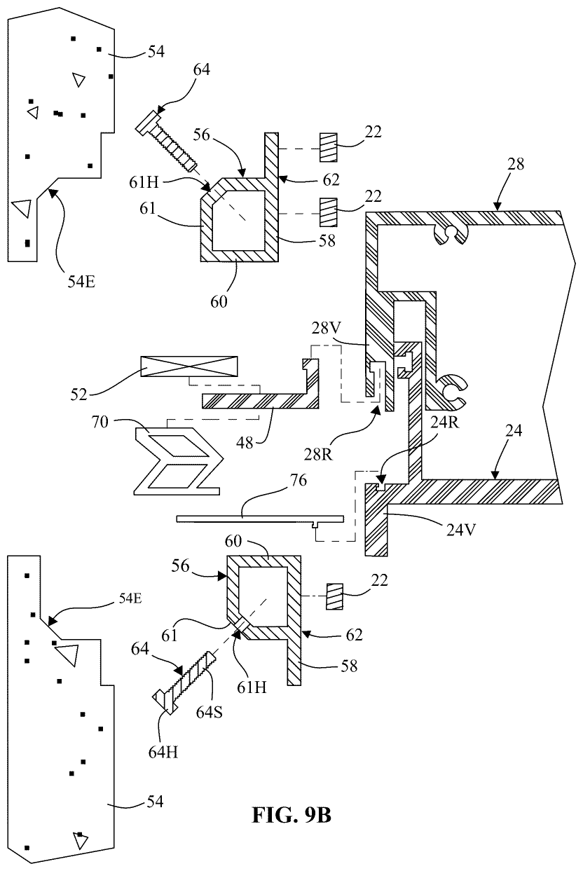

As best seen in FIG. 9, infill support members 28 include a vertical leg 28V and a reglet/groove 28R formed in the vertical leg 28V and opening generally downwardly. L-shaped edge support members 48 can be attached/snapped into the infill support member reglets 28R, whereby the closure panels 12 and the infill panels 16 can be supported on the L-shaped edge support members 48. Setting blocks 52 can be provided between the support members 48 and the panels 12, 16 as may be needed.

As best seen in FIGS. 5, 6A and 10, the edge cover support members 30 can include an edge cover support member exterior wall 30E and an attachment groove 30G provided along the edge cover support member exterior wall 30E. Planar edge support members 50 can be received in the attachment groove 30G and can be snap fastened to the edge cover support members 30. The edge cover panels 14 can be supported on the planar edge support members 50 and setting blocks 52 can be provided between the edge support members 50 and the edge cover panels 14 as may be needed.

As should now be appreciated, the weight of the closure panels 12 and/or infill panels 16 is transferred from the L-shaped edge support members 48 to the infill support members 28, and, therefore, to the vertical mullions 26. Similarly, the weight of the edge cover support panels 14 is transferred from the planar edge support members 50 to the edge cover support members 30 and, therefore, to the vertical mullions 26. Hence, the panels 12, 14, 16, are “hung” via the shelf members 24 on the above floor slab AFS and the vertical mullions 26 are, therefore, in tension.

As best seen in FIG. 9, the shelf members 24 can include a vertical leg 24V and a reglet/groove 24R formed thereabove and opening generally upwardly. Horizontal edge protector shelves 76 attach/snap into the shelf member reglets 24R and extend over the upper ends of the panels 12, 14, respectively. Preferably, flexible weatherseal gaskets 70 can be provided between the horizontal edge protector shelves 76 and the edge support members 48 of adjacent talon wall frameworks 18 supported on successive floor slabs FS. Similarly, as best seen in FIG. 11, flexible mullion weatherseal gaskets 26G can be secured longitudinally along the vertical mullion female half 26f and are sandwiched between adjacent panels 12, 14, 16. The gaskets 70, 28G facilitate thermal expansion and contraction and prevent water entry therebehind.

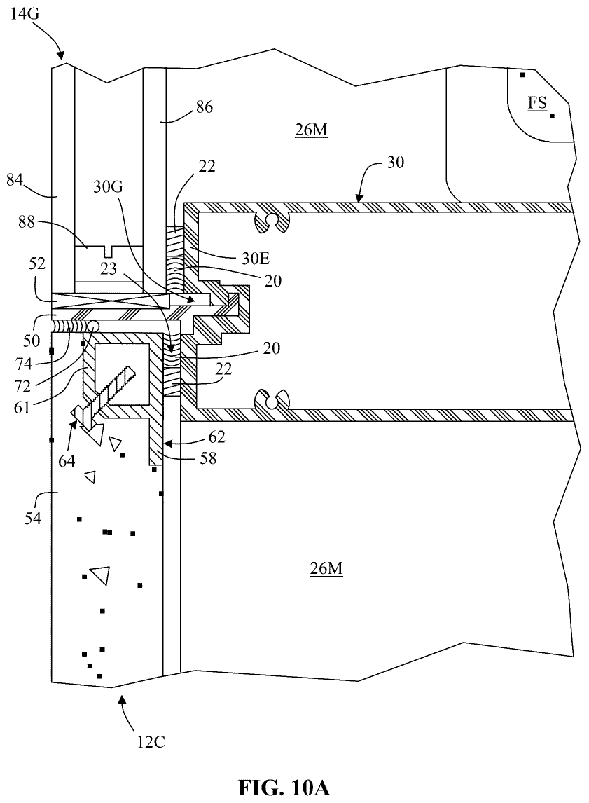

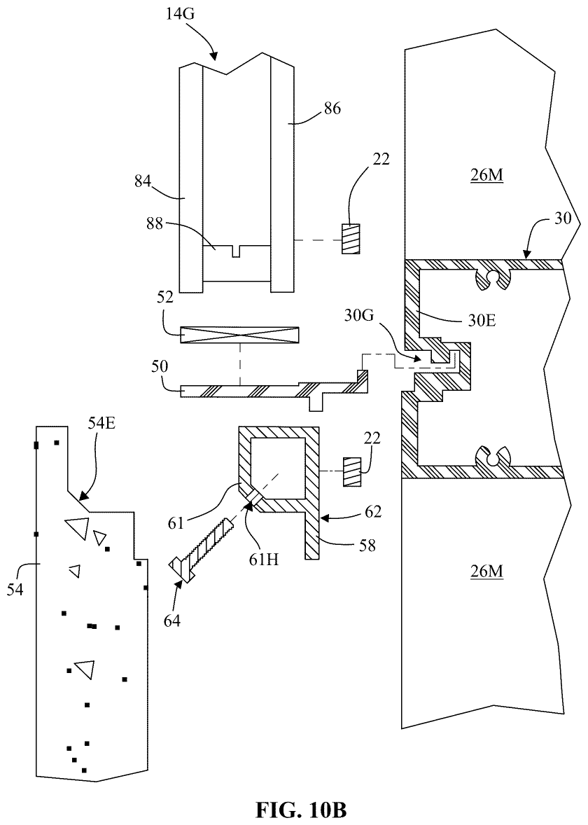

Additionally, as best seen in FIGS. 9 and 10, backer rods 72 can be provided between the upper ends of the panels 12, 14, 16 and the planar edge support members 50 and/or the horizontal edge protector shelves 76, respectively. A weather sealant 74 can be applied over the backer rods 72 and filling the gaps between the panels 12, 14, 16 and the edge support members 50 and/or the edge protector shelves 76, respectively, thereby preventing water entry therebehind. As should now be appreciated, the gaskets 70, 26G, the backer rods 72, and the weather sealant 74 form a weatherproof seal along the perimeter edges of the panels 12, 14, 16.

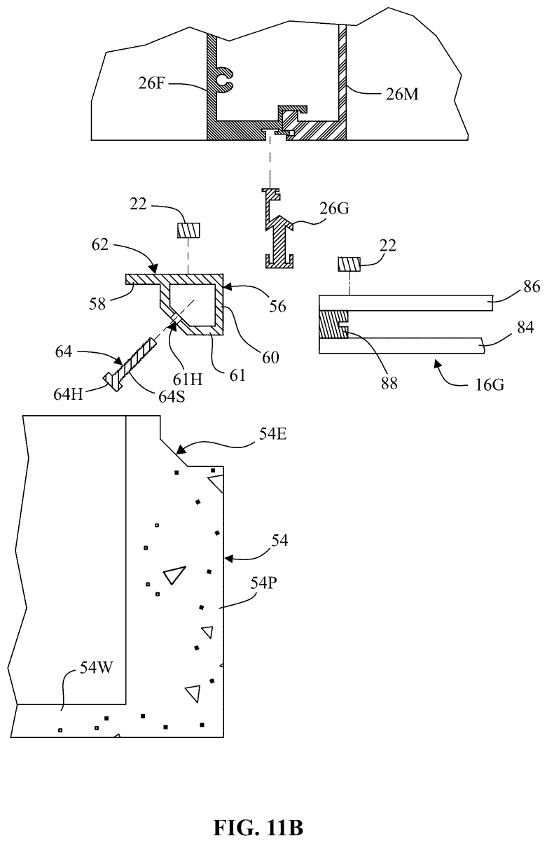

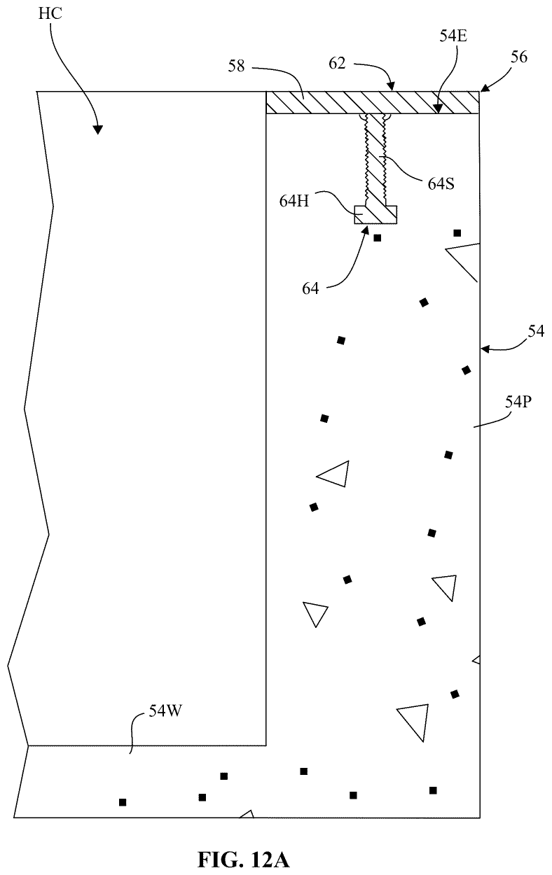

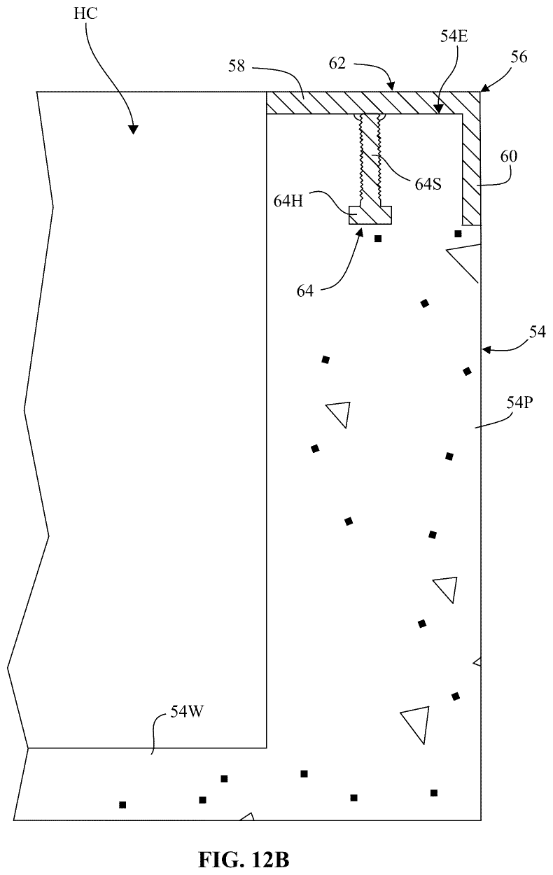

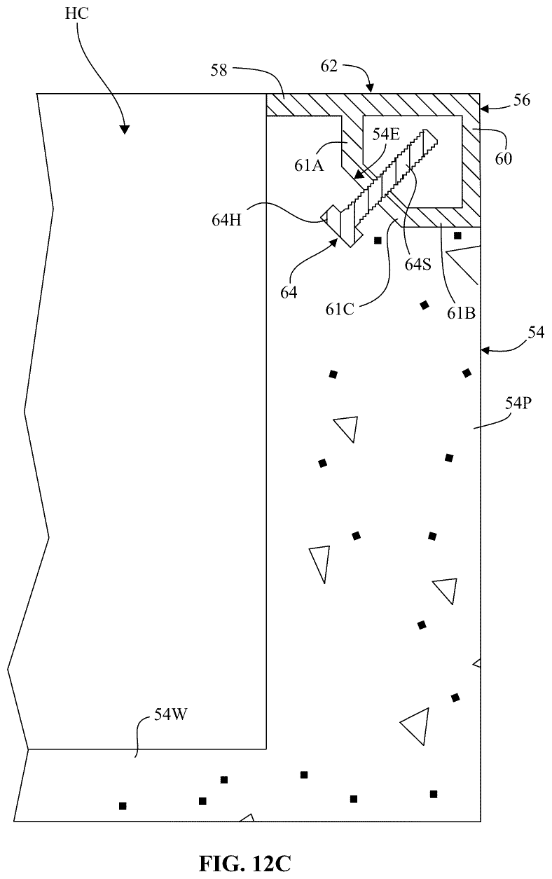

Turning to FIGS. 12A-C, the panels 12, 14, 16 can comprise many different dimensions, layers, and thicknesses as needed or desired, and can be made from a variety of materials, such as, for example, glass, concrete, polymer, stone, steel, aluminum, and other materials as may be needed or desired. Glass panels are commonly used between the floor slabs to provide windows for the building, and concrete, polymer, stone, steel, and/or aluminum panels are commonly used to cover building structural components or form architecturally aesthetically pleasing building exterior shapes and curtain wall surfaces. The panels 12, 14, 16 can also be insulated as needed or desired and can comprise many different dimensions, layers, and thicknesses as needed or desired.

Preferably, the façade system 10 can comprise one or more insulated glass panels 12G, 14G, 16G and one or more cementitious panels 12C, 14C, 16C. The glass panels 12G, 14G, 16G can comprise an exterior glass pane 84 adhered to an interior glass pane 86 along a sandwiched spacer 88 extending along the perimeter thereof, although many other layers can also be used as needed or desired. An insulating air space is thereby provided and sealed between the glass panes 84, 86.

The cementitious panels 12C, 14C, 16C can comprise exterior facing cementitious planar members 54 and perimeter support/glazing frames 56. The exterior facing cementitious planar members 54 form the exterior facing portion of the panels 12C, 14C, 16C. The support/glazing frames 56 are secured to the cementitious planar members 54 along a perimeter area 54E thereof and are adapted for mounting the panels 12C, 14C, 16C to the talon wall framework 18.

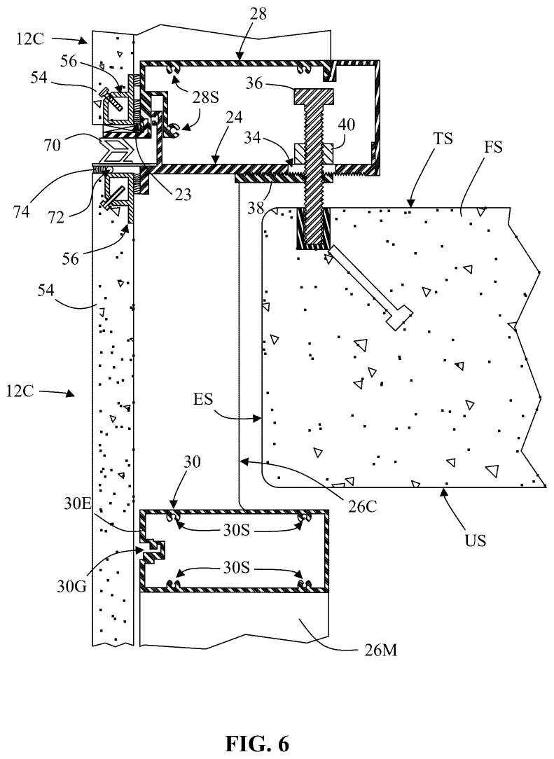

The cementitious planar members 54 are preferably formed, cast, molded, sprayed, and/or otherwise made from materials such as gypsum, concrete, polymers, plastics, resins, carbon, and/or binders with or without embedded reinforcing fibers or metal or metal alloy members, formed in a wide variety of shapes as needed or is architecturally desired. As used herein, “cementitious” is intended to mean and include any one or more of such and/or similar or equivalent materials. As best seen in FIGS. 6A-B, 7A-B, 9A, 9B, 10A and 10B the planar members 54 can be, for example, flat/planar panels comprising a perimeter area 54E whereat the support/glazing frames 56 are secured/embedded.

As best seen in FIGS. 5, 11A, 11B and 12A-C, the cementitious planar members 54 can also be, for example, pan-shaped panels comprising a perimeter area 54E whereat the support/glazing frames 56 are secured/embedded. The pan-shaped panels can include protruding perimeter walls 54P extending perpendicularly away from the support/glazing frames 56, and planar exterior walls 54W extending between the protruding perimeter walls 54P. The pan-shaped cementitious planar members 54 are adapted to protrude outwardly past adjacent glass panels 12G, 14G, 16G and can be used to form façade columns along the side walls SW of building B (FIG. 1A).

Preferably, the protruding perimeter walls 54P are integrally formed with the planar exterior walls 54W. Yet more preferably, a hollow cavity HC is formed and defined between the perimeter walls 54P and the planar exterior walls 54W for thereby reducing the weight of the pan-shaped cementitious planar members 54.

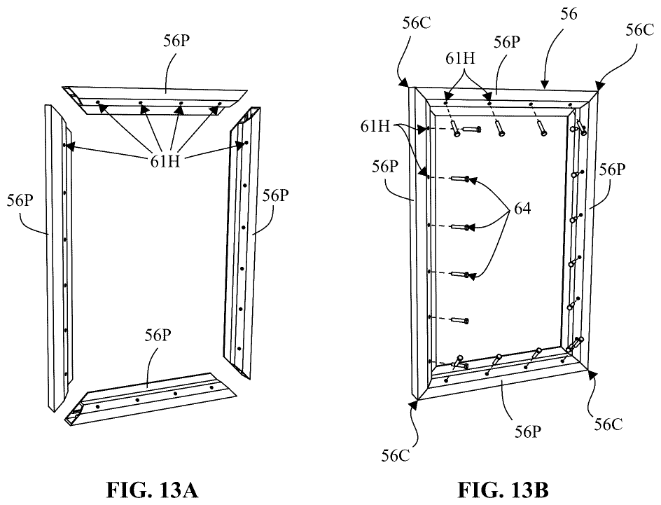

As shown in FIGS. 13A-B, the support/glazing frames 56 can be polygonal frames having a plurality of corners 56C. Preferably, the support/glazing frames 56 are formed from a plurality of elongate members 56P which are joined together at the corners 56C of the frames 56 via joining means, such as, for example, welding, sintering, fastening, or adhering. Preferably, the elongate members 56P can be formed by extruding, injection molding, casting or otherwise molding, forming or shaping from a unitary material or by cutting desired lengths from a stock material which itself may be formed by extruding, injection molding, casting or otherwise molding, forming or shaping from a unitary material. Yet more preferably, the stock material and/or the elongate members 56P can be formed by extrusion molding from a lightweight, malleable, metallic material such as, for example, aluminum.

As best seen in FIGS. 12A-C, the elongate members 56P comprise support/glazing walls 58 and anchor studs 64. The support/glazing walls 58 are adapted to be adhered to the talon wall framework 18 by the structural sealant 20 and/or structural spacer tape 22. The anchor studs 64 are adapted to embed into the cementitious planar members 54 for securing the perimeter support/glazing frames 56 thereto. As will be discussed in greater detail hereinbelow, the perimeter support/glazing frames 56 are preferably, cast/embedded into, and thereby secured to, the cementitious planar members 54 during manufacture thereof.

Preferably, the support/glazing walls 58 include planar glazing surfaces 62 which can be positioned adjacent and facing the talon wall framework 18. The planar glazing surfaces 62 can be configured to optimize adhesion of the support/glazing frames 56 to the talon wall framework 18. For example, the glazing surfaces 62 can be porous such that they partially absorb the structural sealant 20 and/or the adhesive of the tape 22 to thereby promote adhesion of the support/glazing frames 56 to the talon wall framework 18.

The anchor studs 64 can comprise various structures including bolts, barbs, spikes, loops, or other disruptions or protrusions which extend from the glazing frame 56 and are embedded/encased within the cementitious planar members 54 for preventing the glazing frame 56 from pulling away from or out of the cementitious planar members 54. For example, in the present exemplary embodiment the anchor studs 64 comprise a head 64H and a threaded shank 64S extending therefrom. As best seen in FIG. 12A, the shanks 64S can be secured via joining means, such as, for example, welding, sintering, fastening, or adhering, to the support/glazing walls 58 opposite the glazing surfaces 62 with the heads 64H spaced apart from the support/glazing walls 58. When the anchor studs 64 are embedded/encased within the cementitious planar members 54, the heads 64H and the shanks 64S are captured for preventing the anchor studs 64 and the support/glazing walls 58 from pulling away from or out of the cementitious planar members 54.

Preferably, as best seen in FIG. 12B, the elongate members 56P can further include side walls 60 extending perpendicularly from the support/glazing walls 58 whereby the elongate members 56P are L-shaped. The side walls 60 form the perimeter sides of the support/glazing frames 56 and can be adapted to engage the setting blocks 52, weatherseal gaskets 26G, and backer rods 72 such that a weatherseal can be formed between adjacent panels 12, 14, 16.

Yet more preferably, as best seen in FIG. 12C, the elongate members 56P are tubular members further comprising intermediate connector walls 61 extending between and joining the support/glazing walls 58 and the side walls 60. The intermediate connector walls 61 can include a first connector wall 61A which extends perpendicularly from the support/glazing wall 58 and a second connector wall 61B which extends perpendicularly from the side wall 60. Preferably, the intermediate connector walls 61 also include a third connector wall 61C which extends between the first and second connector walls 61A, 61B.

Preferably, the anchor studs 64 are secured to the third connector walls 61C. More particularly, as best seen in FIGS. 9B, 10B, 11B, and 13A-B, the third connector walls 61C can include a plurality of threaded holes 61H adapted to receive and threadingly engage the shanks 64S for thereby securing the anchor members 64 to the third connector walls 61C. Additionally and/or alternatively, the shanks 64S can be further secured to the third connector walls 61C by welding, sintering, fastening, or adhering the shanks 64S within the holes 61H or otherwise directly to the walls 61C. Preferably, the shanks 64S are secured to the third connector walls 61C extending at an approximately forty-five degree angle relative to the support/glazing walls 58.

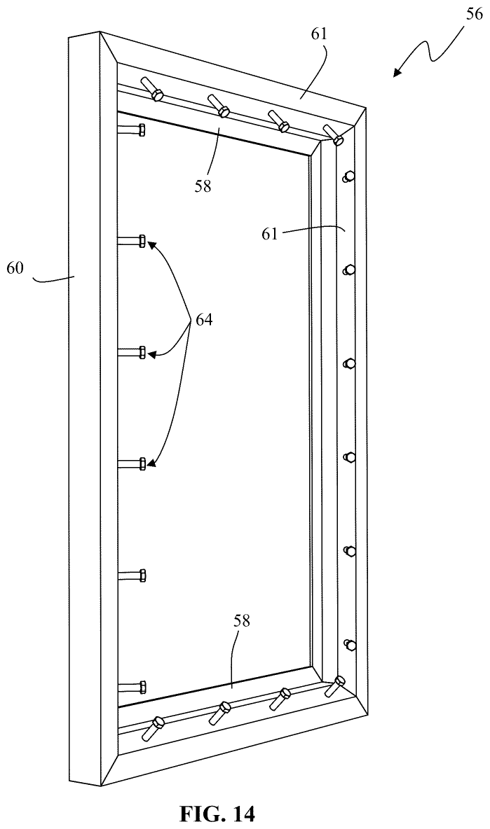

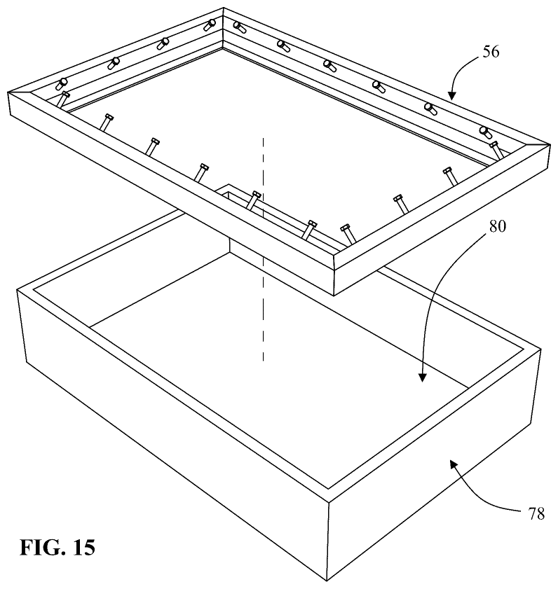

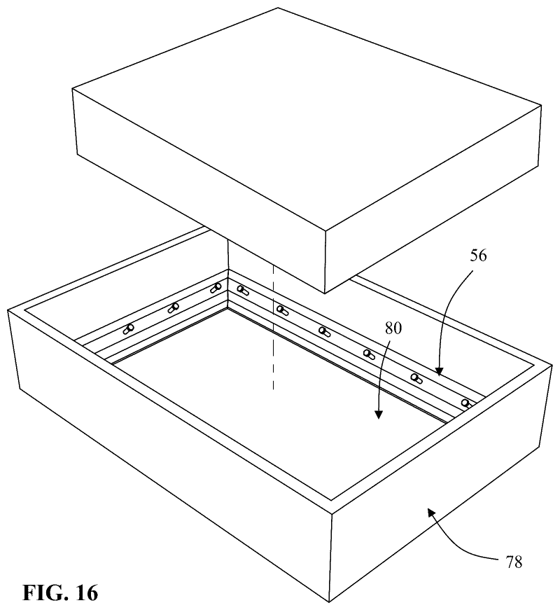

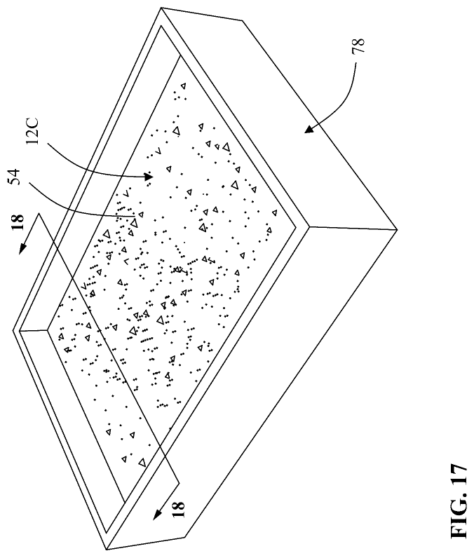

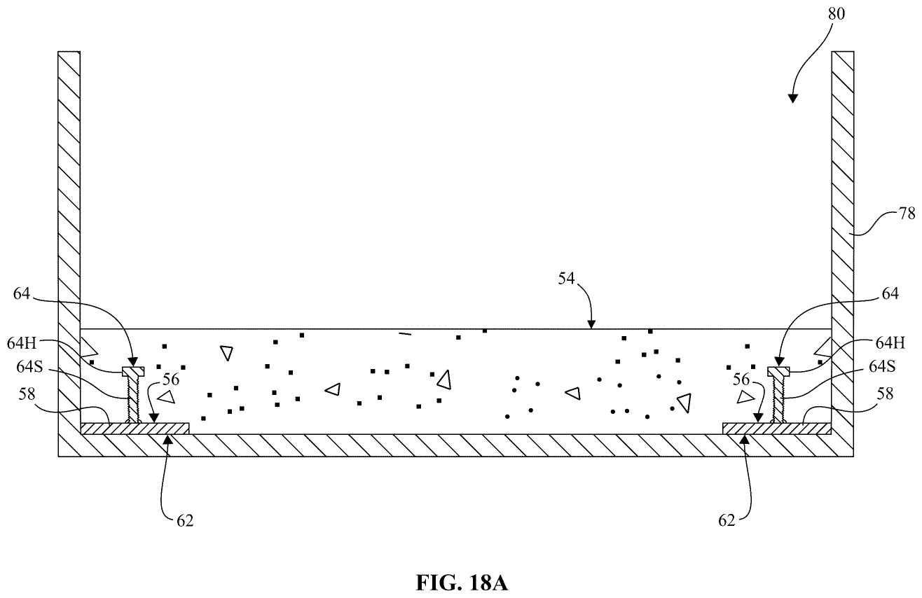

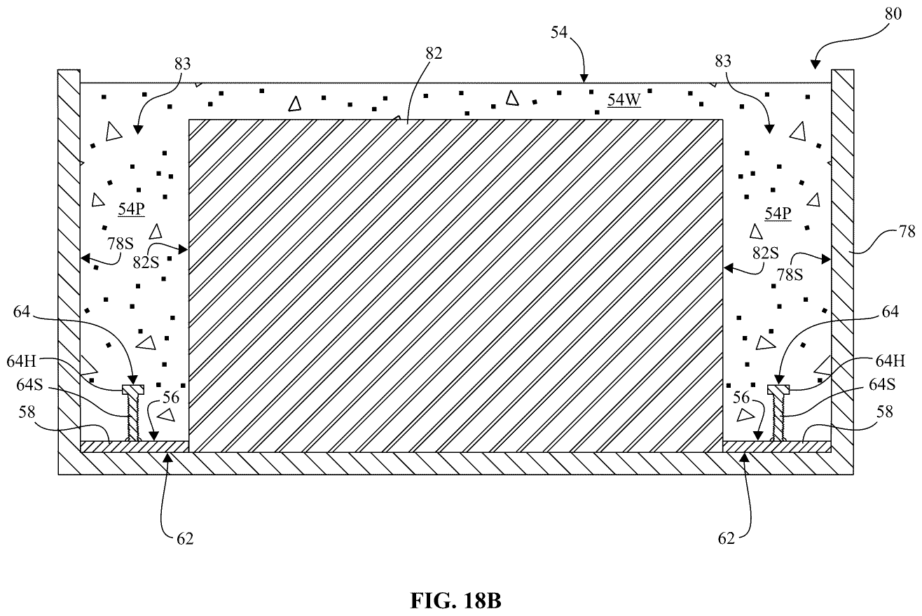

As mentioned hereinabove, the perimeter support/glazing frames 56 are preferably cast/embedded into, and thereby secured to, the cementitious planar members 54 during manufacture thereof. For example, as shown in FIGS. 13-18, a perimeter support/glazing frame 56 can be assembled from a set of elongate members 56P, positioned within a cavity 80 of a mold 78, and cementitious material used for constructing the cementitious planar members 54 can be poured, sprayed, or injected into the mold cavity 80 over the perimeter support/glazing frame 56. As the cementitious material solidifies/cures, the anchor studs 64 are captured/encased within the cementitious planar members 54 as shown in FIGS. 5, 6A-B, 7A-B, 9A, 10A, 11A and 12A-C and the perimeter support/glazing frame 56 is thereby secured to the cementitious planar member 54 at the perimeter 54E thereof.

In the pan-shaped panel embodiment, before the cementitious material is poured, sprayed, or injected into the mold cavity 80, a rectangular removable core 82 can be placed into the mold 80 inside of the support/glazing frame 56 to thereby form the hollow cavity HC and corresponding protruding perimeter walls 54P and planar exterior walls 54W. More particularly, the rectangular removable core 82 can be sized and shaped to fit within the mold cavity 80 inside of the support/glazing frame 56 whereby troughs 83 are formed and defined between the exterior surfaces 82S of the removable core 82 and the interior surfaces 78S of the mold 78. When the cementitious material is poured or injected into the mold 78, the cementitious material fills the troughs 83 and covers the removable core 82 such that, as the cementitious material solidifies/cures, the protruding perimeter walls 54P and the exterior planar walls 54W are integrally formed. The cementitious panel 12C, 14C, 16C can thereafter be removed from the mold 78, and the removable core 82 can be separated from the panel 12C, 14C, 16C, thereby defining the hollow core HC. Of course, the removable core 82 and the mold cavity 80 can be sized and shaped such that the troughs 83 correspond to the desired shape, thickness, etc., of the protruding perimeter walls 54P.

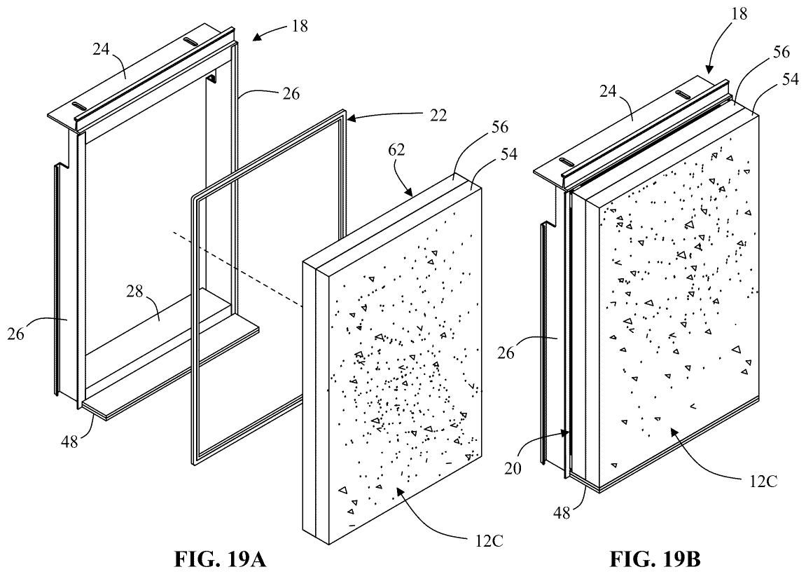

In use, the cementitious panels 12C, 14C, 16C can be secured to talon wall framework 18 using structural sealant 20 and/or structural spacer tape 22. For example, as shown in FIGS. 19A-B, structural spacer tape 22 can be applied to and sandwiched between the support/glazing wall glazing surfaces 62 of the frames 56 and the talon wall framework 18 to adhere the panels 12C, 14C, 16C thereto. As best seen in FIGS. 9A, 10A, and 11A, the structural spacer tape 22 also spaces the support/glazing walls 58 apart from the talon wall framework 18 for forming sealant gaps/slots 23 along the perimeter of the support/glazing walls 58. Preferably, the sealant gaps/slots 23 can be filled with structural sealant 20, and the structural sealant 20 can then be firmly tooled to force the sealant 20 into the sealant gaps/slots 23 and to remove any excess sealant 20. As the structural sealant 20 solidifies/cures, the support/glazing walls 58, and, hence, the cementitious panels 12C, 14C, 16C, are further adhered/secured to the talon wall framework 18. Alternatively, structural sealant 20 can be used alone/without structural spacer tape 22 between the support/glazing wall surfaces 62 of the frames 56 and the talon wall framework 18 (FIG. 29A) or structural spacer tape 22 can be used alone/without structural sealant 20 between the support/glazing wall surfaces 62 of the frames 56 and the talon wall framework 18 (FIG. 29B) to directly adhere/secure the panels 12C, 14C, 16C to the talon wall framework 18.

Preferably, the structural sealant 20 can be, for example, a structural silicone sealant commonly used for glazing/adhering panels to curtain wall framework, and structural spacer tape 22 can be, for example, a high-strength structural glazing spacer tape commonly used for glazing/adhering panels to curtain wall framework. Accordingly, assembly and installation of the building façade system 10 can be streamlined through the use of uniform structural sealants and structural spacer tapes for mounting the glass panels 12G, 14G, 16G and the cementitious panels 12C, 14C, 16C to the talon wall framework 18.

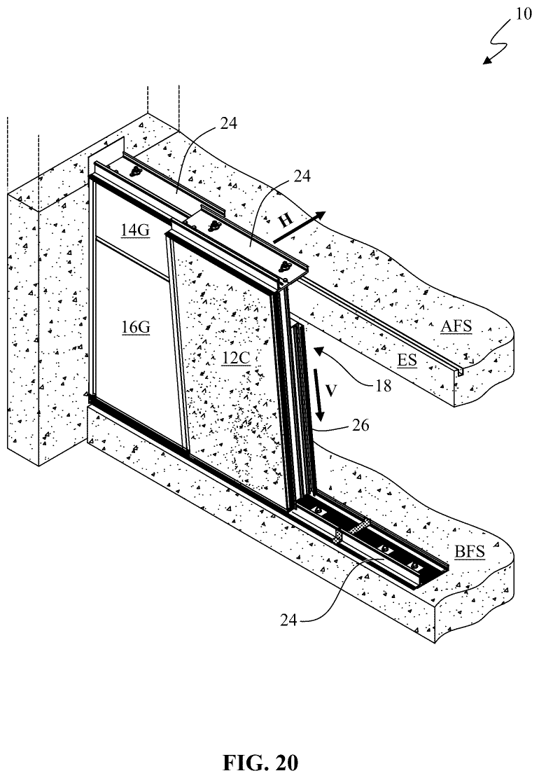

Preferably, the panels 12, 14, 16 can be secured to the talon wall framework 18 before the talon wall framework 18 is securely mounted/hung on the floor slabs FS. For example, as shown in FIG. 20, a cementitious closure panel 12C which has been adhered/secured to a talon wall framework 18 can be installed on a building B by positioning the closure panel 12C and talon wall framework 18 in front of the slab edge surface ES. The closure panel 12C and talon wall framework 18 can then be moved horizontally towards the floor slab FS and/or vertically lowered towards the BFS until the framework lower infill support member 28 engages a shelf member 24 therebelow on the BFS. Preferably, the panels 12, 14, 16 and talon wall frameworks 18 are installed from the interior spaces of the building B.

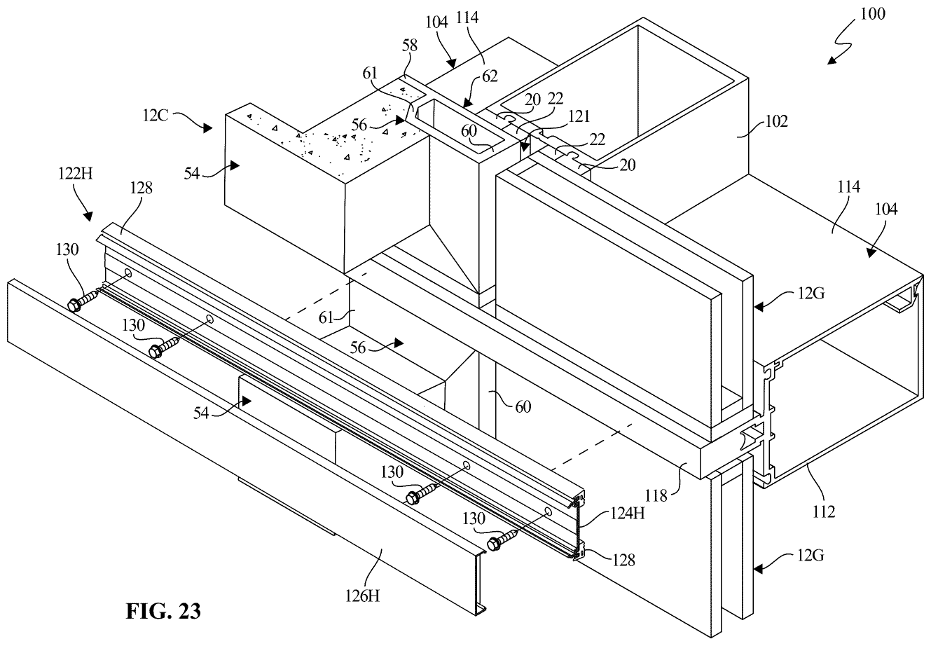

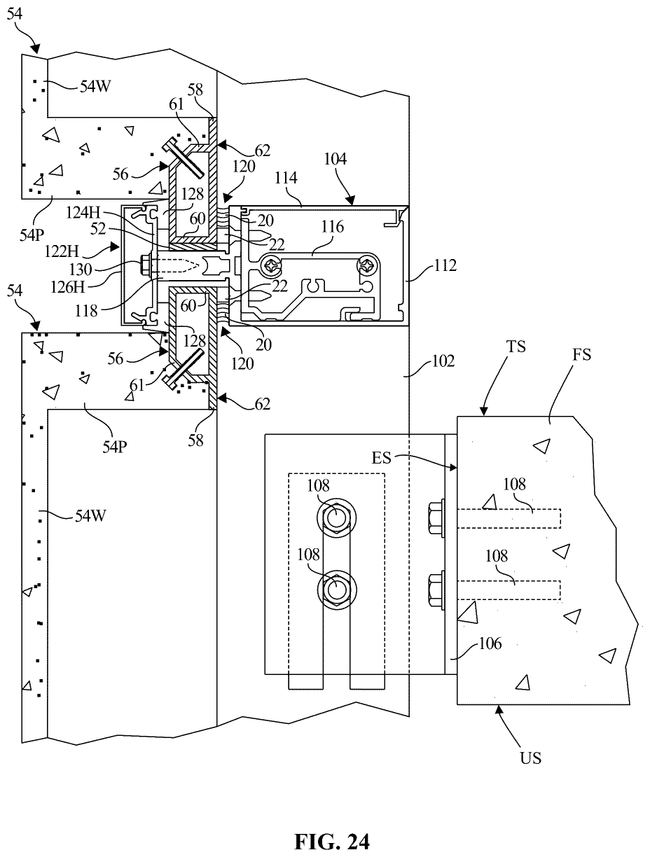

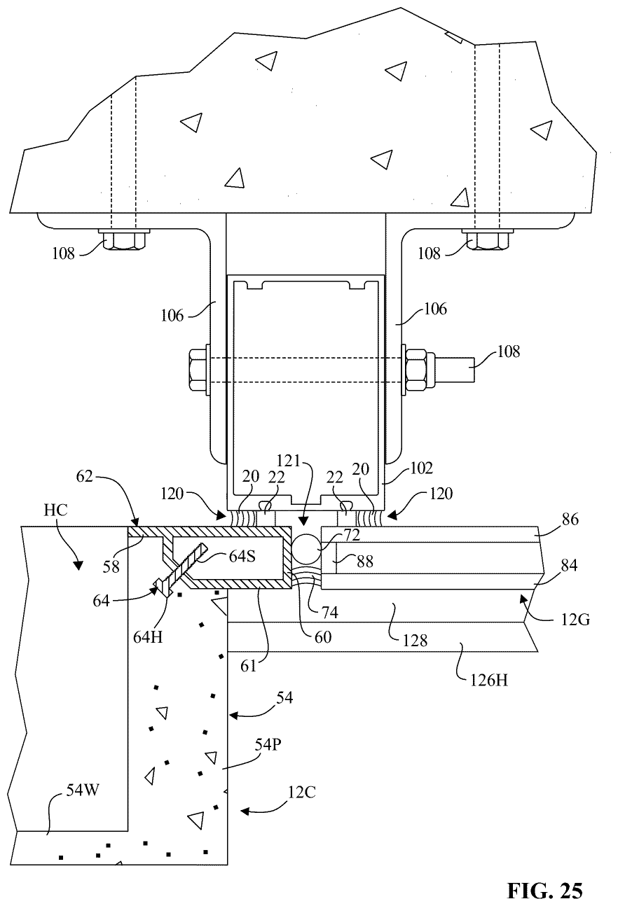

In another embodiment (FIGS. 21-28), the façade system 10 comprises a traditional curtain wall framework 100, such as, for example, a Kawneer 1600 Wall System, which is secured to one or more of the floor slabs FS and forms an exoskeleton around the building B. The traditional framework 100 comprises vertical mullions 102 and horizontal head/sill members 104. The vertical mullions 102 are secured to and extend vertically between the floor slabs FS. Preferably, the vertical mullions 102 are secured directly to the floor slabs FS by L-shaped mounting brackets 106 and fasteners 108, for example, as shown in FIGS. 24 and 25.

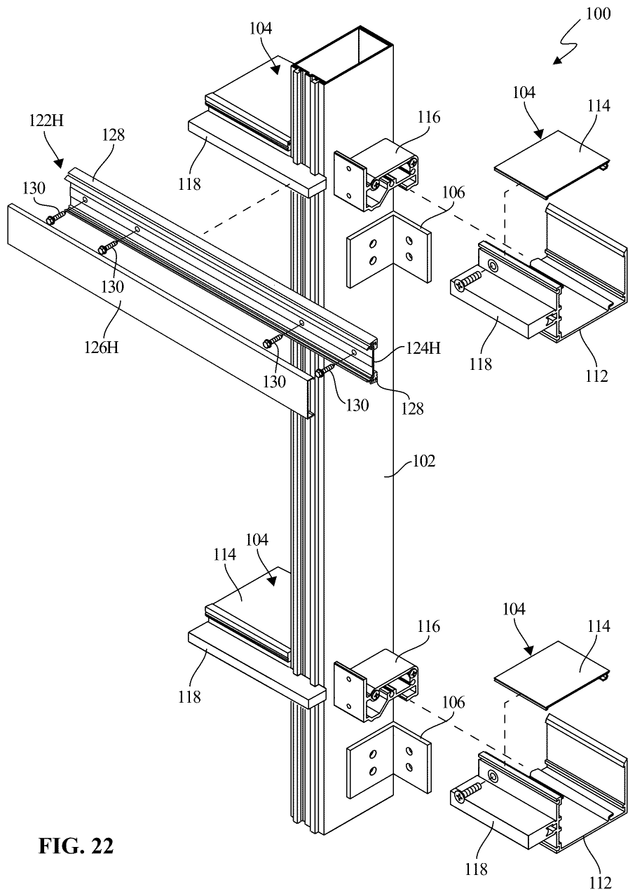

The horizontal head/sill members 104 are secured to and extend horizontally between adjacent pairs of vertical mullions 102 whereby a plurality of rectangular closure frames 110 (FIG. 21) are formed and defined between the adjacent pairs of vertical mullions 102 and adjacent pairs of head/sill members 104. As best seen in FIGS. 22 and 23, the horizontal head/sill members 104 preferably comprise a U-shaped channel 112 and a cover panel 114 which are configured to securely snap together. The U-shaped channels 112 are configured to engage and couple to shear blocks 116 which are secured to the sides of the vertical mullions 102. The U-shaped channels 112 also include horizontal support beams 118 which extend horizontally from the side of the U-shaped channel 112. The support beams 118 are adapted to support closure panels 12 and setting blocks 52 can be provided between the support beams 118 and the panels 12 as may be needed.

In use, cementitious closure panels 12C can be secured to the rectangular closure frames 110 using structural sealant 20 and/or structural spacer tape 22. For example, as shown in FIGS. 24 and 25, structural spacer tape 22 can be applied to and sandwiched between the support/glazing wall glazing surfaces 62 and the horizontal head/sill members 104 and vertical mullions 102 of the traditional framework 100 to adhere the panels 12C thereto. The structural spacer tape 22 also spaces the support/glazing walls 58 apart from the traditional framework 100 for forming sealant gaps/slots 120 along the perimeter of the support/glazing walls 58. Preferably, the sealant gaps/slots 120 can be filled with structural sealant 20, and the structural sealant 20 can then be firmly tooled to force the sealant 20 into the sealant gaps/slots 120 and to remove any excess sealant 20. As the structural sealant 20 solidifies/cures, the support/glazing walls 58, and, hence, the cementitious panels 12C, are further adhered/secured to the traditional framework 100. Alternatively, structural sealant 20 can be used alone/without structural spacer tape 22 between the support/glazing wall surfaces 62 of the frames 56 and the traditional framework 100 (FIG. 30A) or structural spacer tape 22 can be used alone/without structural sealant 20 between the support/glazing wall surfaces 62 of the frames 56 and the traditional framework 100 (FIG. 30B) to directly adhere/secure the panels 12C to the traditional framework 100. Additionally, the vertical gaps/slots 121 between adjacent closure panels 12 are preferably sealed using a foam backer rod 72 and weather sealant 74 for thereby creating a watertight seal therebetween.

The traditional framework 100 preferably also includes horizontal weatherseal plates 122H which are adapted to be secured to the support beams 118 and form a weatherproof seal along the horizontal ends of the panels 12. Specifically, the horizontal weatherseal plates 122H comprise a pressure plate 124H and a cover 126H which securely snaps onto the pressure plate 124H. As best seen in FIGS. 23 and 24, the pressure plates 124H include weatherseal gaskets 128 which are mounted extending along the plate's longitudinal side edges. In use, the pressure plates 124H are adapted to be secured to the support beams 118 by fasteners 130 with the weatherseal gaskets 128 engaging and sealing against the panels 12. As best seen in FIGS. 23-25, the glazing frames 56 of the cementitious panels 12C can be configured to project outwardly from the perimeter of the cementitious planar members 54, for example, as best seen in FIG. 23. When the pressure plate 124H is secured to the support beams 118, the weatherseal gaskets 128 engage and seal against the glazing frame intermediate connector walls 61 for thereby preventing water entry therebehind.

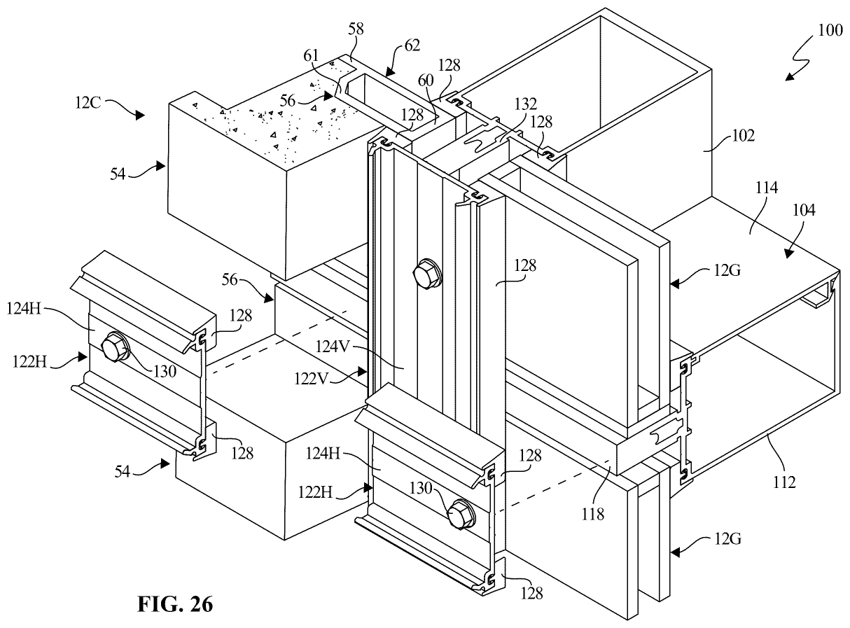

In another embodiment (FIGS. 26-28), the traditional framework 100 further includes vertical weatherseal plates 122V. Like the horizontal weatherseal plates 122H, the vertical weatherseal plates 122V comprise pressure plates 124V having weatherseal gaskets 128 mounted thereto and covers 126V which securely snap onto the pressure plates 124V. The pressure plates 124V are adapted to be secured to vertical support walls 132 which extend from the exterior side of the vertical mullions 102 with the weatherseal gaskets 118 engaging and sealing against the panels 12.

In this embodiment, the cementitious closure panels 12C can be secured to the framework 100 by sandwiching and clamping the protruding portion of the glazing frames 56 between the traditional framework 100 and the weatherseal plates 122H, 122V. Specifically, the traditional framework 100 can include weatherseal gaskets 128 which are mounted extending along the longitudinal side edges of the vertical mullions 102 and the horizontal head/sill members 104. When the cementitious panels 12C are mounted to the framework 100, the support/glazing wall surfaces 62 engage and abut against the weatherseal gaskets 118 mounted to the mullions 102 and the head/sill members 104. The weatherseal plates 122H, 122V are then mounted to the horizontal support beams 118 and vertical support walls 132 whereby the protruding portion of the glazing frame 56 is sandwiched and clamped between the weatherseal gaskets 128 of the weatherseal plates 122H, 122V and the weatherseal gaskets 128 of the mullions 102 and head/sill members 104.

While this invention has been described as having an exemplary design, the present invention may be further modified within the spirit and scope of this disclosure. This application is therefore intended to cover any variations, uses, or adaptations of the invention using its general principles.

What is claimed is:

1. A building façade secured to a building structure comprising a plurality of vertically stacked levels defined by horizontally arranged floors therebetween, the building façade comprising:
a framework mounted to one or more of the floors; and
one or more cementitious façade panels which comprise:
a cementitious planar member; and
a glazing frame secured to the cementitious planar member;
wherein the one or more cementitious façade panels are mounted to the framework by adhering the glazing frames thereto.

2. The building facade of claim 1, wherein the framework is hung from an above floor and extends downwardly toward a below floor, and wherein the one or more cementitious façade panels are adhered to the framework before it is hung from the above floor.

3. The building facade of claim 1, wherein the framework forms an exoskeleton around the building structure, and wherein the one or more cementitious façade panels are adhered to the framework after it is mounted to one or more of the floors.

4. The building façade of claim 1, wherein the glazing frame is at least partially embedded into the cementitious planar member during the manufacture thereof.

5. The building façade of claim 1, wherein the glazing frame comprises a plurality of anchor studs, and wherein the anchor studs are embedded into the cementitious planar member during the manufacture thereof for thereby securing the glazing frame thereto.

6. The building facade of claim 1, wherein the glazing frame is adhered to the framework with a sealant applied between the framework and the glazing frame.

7. The building facade of claim 1, wherein the glazing frame is adhered to the framework with tape sandwiched between the glazing frame and the framework.

8. The building façade of claim 7, wherein the tape is a structural spacer tape which spaces the glazing frame apart from the framework for thereby forming gaps/slots therebetween, and wherein a structural sealant fills the gaps/slots and forms an airtight, weatherseal along the perimeter of the glazing frame.

9. The building façade of claim 1, wherein the framework comprises a rectangular closure frame formed and defined with sides extending along a horizontal shelf member, a pair of vertical mullions, and a horizontal infill support member, and wherein the cementitious façade panel is correspondingly rectangular shaped and is adhered along a perimeter surface thereof to the rectangular closure frame.

10. The building facade of claim 1, wherein the framework comprises:
a horizontal shelf member;
a pair of vertical mullions hung from the horizontal shelf member;
a horizontal infill support member secured to, and extending between, lower terminal ends the pair of vertical mullions; and,
a horizontal edge cover support member secured to, and extending between, the pair of vertical mullions vertically between the horizontal shelf member and the horizontal infill support member;
wherein a rectangular closure frame is formed and defined between the horizontal shelf member, the pair of vertical mullions, and the infill support member;
wherein a rectangular infill frame is formed and defined between horizontal edge cover support member, the pair of vertical mullions, and the infill support member;
wherein a rectangular edge cover frame is formed and defined between the horizontal shelf member, the pair of vertical mullions, and the infill support member; and,
wherein the cementitious façade panel is sized to fit within and be adhered to one or more of the rectangular closure frame, the rectangular infill frame, and the rectangular edge cover frame.

11. The building façade of claim 1, wherein the cementitious planar member is a flat panel.

12. The building façade of claim 1, wherein the cementitious planar member is hollow.

13. The building facade of claim 1, wherein the cementitious planar member is pan-shaped comprising protruding perimeter walls extending away from the glazing frame, a planar exterior wall extending between the protruding perimeter walls, and a hollow cavity formed and defined between the protruding perimeter walls and the planar exterior wall.

14. The building facade of claim 1, wherein the glazing frame is integrally formed from a unitary material.

15. The building façade of claim 1, wherein the glazing frame is constructed from a plurality of elongate members formed by either cutting desired lengths from a stock material or by extruding, injection molding, casting or otherwise molding, forming or shaping from a unitary material.

16. The building façade of claim 15, wherein the plurality of elongate members comprise glazing walls and a plurality of anchor studs secured to the glazing walls, wherein the glazing walls are adhered to the framework, and wherein the anchor studs are embedded into the planar cementitious member during manufacture thereof for securing the glazing frame thereto.

17. The building facade of claim 16, wherein the plurality of elongate members further comprise side walls extending perpendicularly from the glazing walls, and wherein one or more gaskets engage the side walls for thereby forming a weatherseal along a perimeter of the cementitious façade panel.

18. The building façade of claim 15, wherein the plurality of elongate members comprise glazing walls, side walls extending perpendicularly from the glazing walls, intermediate connector walls extending between the glazing walls and the side walls, and a plurality of anchor studs secured to the intermediate connector walls, wherein the glazing walls are adhered to the framework, and wherein the anchor studs are embedded into the cementitious planar member during manufacture thereof.

19. The building facade of claim 2, wherein the cementitious planar member comprises one of more of gypsum, concrete, polymers, plastics, resins, carbon, and/or binders with or without embedded reinforcing fibers or metal or metal alloy members.

20. The building façade of claim 3, wherein the cementitious planar member comprises one of more of gypsum, concrete, polymers, plastics, resins, carbon, and/or binders with or without embedded reinforcing fibers or metal or metal alloy members.

21. A method of manufacturing and installing a building façade on a building structure comprising a plurality of vertically stacked levels defined by horizontally arranged floors therebetween, wherein the building façade comprises a framework secured to the building structure and one or more cementitious façade panels, the method of manufacturing comprising the steps of:
securing a glazing frame to a cementitious planar member to thereby produce a cementitious façade panel; and,
mounting the cementitious façade panel to the framework by adhering the glazing frame thereto.

22. The method of claim 21, wherein the framework is hung from an above floor and extends downwardly toward a below floor, and wherein the one or more cementitious façade panels are adhered to the framework before it is hung from the above floor.

23. The method of claim 21, wherein the framework forms an exoskeleton around the building structure, and wherein the one or more cementitious façade panels are adhered to the framework after it is mounted to one or more of the floors.

24. The method of claim 21, wherein the step of securing the glazing frame to the cementitious planar member comprises the step of embedding at least a portion of the glazing frame into the cementitious planar member.

25. The method of claim 21, further comprising providing a plurality of anchor studs extending from the glazing frame and wherein the step of securing the glazing frame to the cementitious planar member comprises the step of embedding the anchor studs into the cementitious planar member.

26. The method of claim 21, wherein the step of securing the glazing frame to the cementitious planar member comprises the steps of:
placing the glazing frame into a mold; and,
filling or spraying a liquid cementitious material into the mold;
wherein, as the liquid cementitious material solidifies/cures, the planar cementitious member is formed, and the glazing frame is embedded therein.

27. The method of claim 21, wherein the step of securing the glazing frame to the cementitious planar member comprises the steps of:
placing the glazing frame into a mold;
placing a removable core into the mold inside of the glazing frame;
filling the mold with a liquid cementitious material;
removing the glazing frame and the cementitious planar member from the mold after the liquid cementitious material solidifies; and,
removing the removable core and there forming a hollow cavity within the cementitious planar member.

28. The method of claim 21, wherein the step of mounting the cementitious façade panel to the framework by adhering the glazing frame thereto comprises the steps of:
applying tape to either the glazing frame or the framework; and,
sandwiching the tape between the glazing frame and the framework, whereby the tape adheres the glazing frame to the framework.

29. The method of claim 21, wherein the step of mounting the cementitious façade panel to the framework by adhering the glazing frame thereto comprises the steps of:
positioning the glazing frame adjacent to the framework; and,
applying a sealant to the glazing frame and the framework along a perimeter edge of the glazing frame, wherein the sealant adheres glazing frame to the framework.

30. The method of claim 21, wherein the step of mounting the cementitious façade panel to the framework by adhering the glazing frame thereto comprises the steps of:
applying a structural spacer tape to either the glazing frame or the framework;
sandwiching the structural spacer tape between the glazing frame and the framework, wherein the structural spacer tape spaces the glazing frame from the framework and forms slots/gaps therebetween; and,
filling the slots/gaps with a structural sealant;
wherein the structural spacer tape and the structural sealant together adhere the glazing frame to the framework.

32. The method of claim 22, wherein the cementitious planar member comprises one of more of gypsum, concrete, polymers, plastics, resins, carbon, and/or binders with or without embedded reinforcing fibers or metal or metal alloy members.

33. The method of claim 23, wherein the cementitious planar member comprises one of more of gypsum, concrete, polymers, plastics, resins, carbon, and/or binders with or without embedded reinforcing fibers or metal or metal alloy members.

34. A building façade secured to a building structure comprising a plurality of vertically stacked levels defined by horizontally arranged floors therebetween, the building façade comprising:
a framework mounted to one or more of the floors;
one or more cementitious façade panels which comprise:
a cementitious planar member; and
a glazing frame secured to the cementitious planar member;
one or more weatherseal plates which mount to the framework;
wherein the one or more cementitious façade panels are mounted to the framework by sandwiching a portion of the glazing frames between the framework and the one or more weatherseal plates.
